(19) United States
(12) Patent Application Publication
(10) Pub. No.: US 2011/0256872 A1
(43) Pub. Date: Oct. 20, 2011

(54) APPARATUS AND METHOD FOR A HANDOVER IN MOBILE COMMUNICATION SYSTEM

(75) Inventor: Lixiang XU, Beijing (CN)

(73) Assignee: SAMSUNG ELECTRONICS CO. LTD., Suwon-si (KR)

(21) Appl. No.: 13/085,756

(22) Filed: Apr. 13, 2011

(30) Foreign Application Priority Data
Apr. 15, 2010 (CN) 201010149824.7
Jun. 7, 2010 (CN) 201010195937.0

(51) Int. Cl. H04W 36/00

(52) U.S. Cl. 455/436

(57) ABSTRACT

An apparatus and a method for a handover in a mobile communication system are provided. A method for an operation of a gateway in a mobile communication system includes receiving a message informing of a handover of a User Equipment (UE) from a Base Station (BS), determining whether the handover could be terminated at the gateway, and if it is determined the handover could be terminated at the gateway, performing the handover with the handover being terminated at the gateway.

### PRIORITY

This application claims the benefit under 35 U.S.C. §119(a) of a Chinese patent application filed in the Chinese Intellectual Property Office on Apr. 15, 2010 and assigned Serial No. 201010149824.7, the entire disclosure of which is hereby incorporated by reference.

### BACKGROUND OF THE INVENTION

1. Field of the Invention

The present invention relates to the field of mobile communication technologies. More particularly, the present invention relates to an apparatus and a method for a handover in a mobile communication system.

2. Description of the Related Art

The Long Term Evolution (LTE) technology is a kind of evolution technology in the 3^{rd} Generation (3G) mobile communication system, having the advantages of increasing capacity of a cell, reducing system delay, and so on.

FIG. 1 is a schematic diagram illustrating the structure of an LTE system according to the related art.

Referring to FIG. 1, an Evolved-Universal Terrestrial Radio Access Network (E-UTRAN) 110 of the LTE system mainly includes radio resource management entities such as a macro Base Station (BS) 120 and a small BS 130 and may further include a small BS GateWay (GW) 140. The macro BS 120 may be referred as an ‘eNode B (eNB)’, and the small BS may be referred as a ‘Home eNB (HeNB)’. When the small BS GW 140 is not included in the E-UTRAN 110, the small BS 130 may be connected directly with a Mobile Management Entity (MME) 150 in a core network. When the small BS GW 140 is included in the E-UTRAN 110, the small BS 130 is connected with the MME 150 through the small BS GW 140. The MME 150 is an important network entity in the core network and is responsible for implementing the functions of establishment of radio access bearer, mobile management, and so on.

In a mobile communication system, to provide certain subscribers with better services, usually multiple radio resource management entities should be grouped into a Closed Subscriber Group (CSG) for a specific group of subscribers. For example, all subscribers in a company or school form a specific group of subscribers, for which multiple radio resource management entities are grouped into a CSG so as to provide a special access service.

To provide more abundant access services, the radio resource management entities in the LTE system as illustrated in FIG. 1 usually include multiple types, including, in the case of an HeNB, open type, hybrid type and closed subscriber group type. The open type HeNB is not special for any specific group of subscribers and can be accessed by any User Equipment (UE). The closed subscriber group type HeNB is located in a closed subscriber group and permits access only by a UE in a specific group of subscribers served by it. The hybrid HeNB supports the functions of a closed subscriber group, and permits both access by UE in a specific group of subscribers served by it and access by a UE in a non-specific group of subscribers.

A UE may move among different HeNBs, which can be implemented through handovers.

FIG. 2 is a handover process in a mobile communication system according to the related art.

Referring to FIG. 2, assuming HeNBs are connected with an MME through an HeNB GW, the handover process includes the following steps.

In step 201, a source small BS 220 transmits a handover required message to the small BS GW 240. How the UE 210 transmits a measurement report to the source small BS 220 and how the source small BS 220 initiates a handover will not be described here for conciseness in explanation. In step 203, the small BS GW 240 transmits a handover required message to the MME 250. In step 205, the MME 250 transmits a handover request message to the small BS GW 240 and the small BS GW 240 transmits a handover request message to a target small BS 230. The source small BS 220 is a small BS serving the UE 210 originally and the target small BS 230 is a small BS to which the UE 210 is to be handed over. The target small BS may be referred to as a ‘destination small BS’. In step 207, the target small BS 230 allocates resources for the UE 210 and transmits a handover request acknowledge message to the small BS GW 240 and the small BS GW 240 transmits a handover request acknowledge message to the MME 250. In step 209, the MME 250 transmits a handover command message to the small BS GW 240 and the small BS GW 240 transmits a handover command message to the source small BS 220. In step 211, the source small BS 220 transmits a handover command message to the UE 210. In step 213, the UE 210 is synchronized with a target cell and transmits a handover confirm message to the target small BS 230. In step 215, the target small BS 230 transmits a handover notify message to the small BS GW 240 and the small BS GW 240 transmits a handover notify message to the MME 250. In step 217, the MME 250 transmits an update bearer request message to a Serving GateWay/Packet Data Network GateWay (S-GW/PDN GW) 260. The S-GW mainly provides the function of the user plane. The PDN GW is mainly responsible for the functions of charging, lawful interception and so on. The S-GW and the PDN GW may be located physically at the same entity or two different entities. A description of the signaling interactions between the S-GW and the PDN GW are omitted herein for conciseness in explanation. In step 219, the S-GW/PDN_GW 260 transmits an update bearer response message to the MME 250. In step 221, a Tracking Area Update (TAU) is performed. In step 223, the MME 250 transmits a UE context release command message to the small BS GW 240 and the small BS GW 240 transmits a UE context release command message to the source small BS 220. In step 225, the source small BS 220 transmits a UE context release complete message to the small BS GW 240 and the small BS GW 240 transmits a UE context release complete message to the MME 250.

Although the above process can implement a handover, if each handover is to be implemented through the MME, heavy processing loads will be exerted on the core network side and the handover efficiency will be reduced due to the large number of HeNBs and the frequent handovers of the UE.

### SUMMARY OF THE INVENTION

Aspects of the present invention address at least the above-mentioned problems and/or disadvantages and provide at least the advantages described below. Accordingly, an aspect of the present invention is to provide an apparatus and a method for reducing operation of a core network load due to a handover in a mobile communication system.

Another aspect of the present invention is to provide an apparatus and method for increasing efficiency of a handover in a mobile communication system.

Another aspect of the present invention is to provide an apparatus and method for controlling a gateway to operate as a terminal of a handover in a mobile communication system.

Another aspect of the present invention is to provide an apparatus and method for determining whether a handover could be terminated at a gateway in a mobile communication system.

In accordance with an aspect of the present invention, a method for an operation of a gateway in a mobile communication system is provided. The method includes receiving a message informing of a handover of a User Equipment (UE) from a Base Station (BS), determining whether the handover could be terminated at the gateway, and if it is determined the handover could be terminated at the gateway, performing the handover with the handover being terminated at the gateway.

In accordance with another aspect of the present invention, a method for an operation of a Mobile Management Entity (MME) in a mobile communication system is provided. The method includes receiving a message informing of an access of a UE through a gateway, transmitting reference information to the gateway that is used by the gateway to determine whether the handover could be terminated at the gateway.

In accordance with another aspect of the present invention, an apparatus for a gateway in a mobile communication system is provided. The apparatus includes a communicator for receiving a message informing of a handover of a UE from a BS, and a controller for determining whether the handover could be terminated at the gateway and, if it is determined that the handover could be terminated at the gateway, for performing the handover with the handover being terminated at the gateway.

In accordance with another aspect of the present invention, an apparatus for a MME in a mobile communication system is provided. The apparatus includes a communicator for receiving a message informing of an access of a UE through a gateway, and a controller for providing the gateway with reference information that is used by the gateway to determine whether the handover could be terminated at the gateway.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a schematic diagram illustrating the structure of a Long Term Evolution (LTE) system according to the related art.

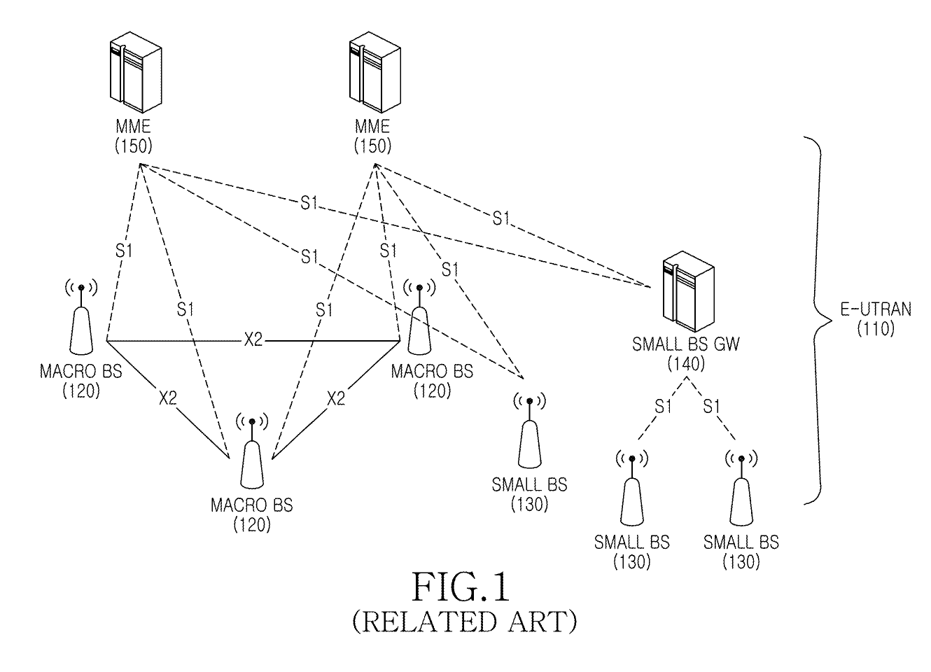

FIG. 2 is a handover process in a mobile communication system according to the related art.

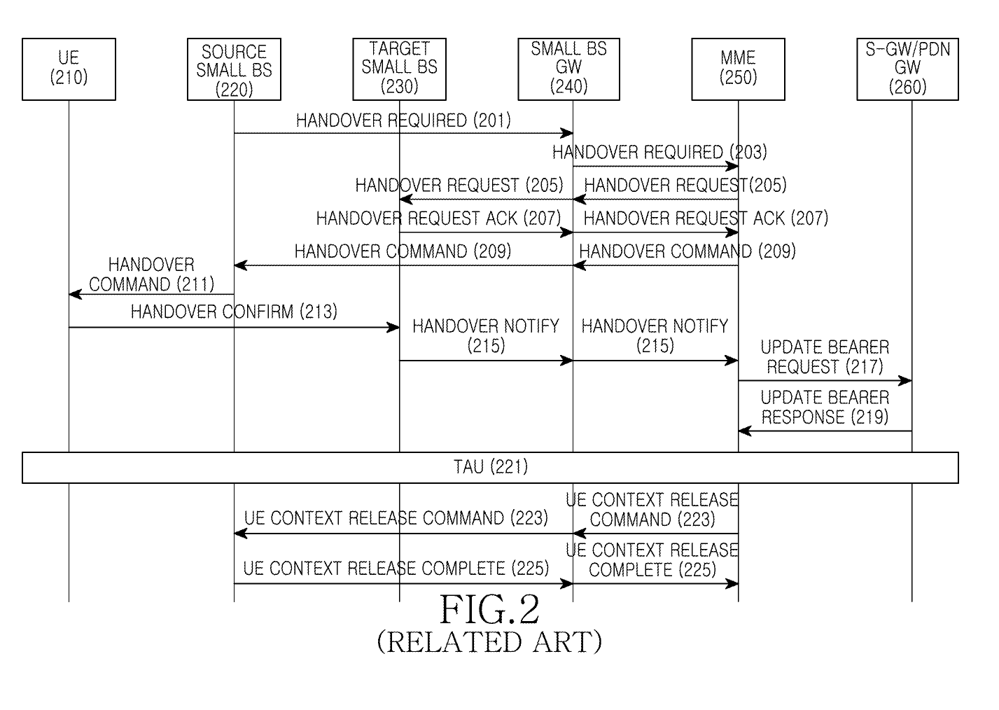

FIG. 3A is a flowchart illustrating a first exemplary embodiment in which a Mobile Management Entity (MME) determines whether a handover could be terminated at a gateway and transmits a determination result to the gateway, according to an exemplary embodiment of the present invention.

FIG. 3B is a flowchart for indicating that a downlink node is a Home eNode B (HeNB) GateWay (GW) in an existing S1 establishment process according to an exemplary embodiment of the present invention.

FIG. 4 is a flowchart illustrating a second exemplary embodiment in which an MME determines whether a handover could be terminated at a gateway and transmits a determination result to the gateway, according to an exemplary embodiment of the present invention.

FIG. 5 is a flowchart illustrating a first exemplary embodiment of an updating process according to an exemplary embodiment of the present invention.

FIG. 6 is a flowchart illustrating a first exemplary embodiment of a handover process according to an exemplary embodiment of the present invention.

FIG. 7 is a flowchart illustrating a second exemplary embodiment of a handover process according to an exemplary embodiment of the present invention.

FIG. 8 is a flowchart illustrating a third exemplary embodiment of a handover process according to an exemplary embodiment of the present invention.

FIG. 9 is a flowchart illustrating a first exemplary embodiment in which an MME transmits a User Equipment (UE) location change reporting action and/or Closed Subscriber Group (CSG) information reporting action to a gateway, according to an exemplary embodiment of the present invention.

FIG. 10 is a flowchart illustrating a second exemplary embodiment in which an MME transmits a UE location change reporting action and/or CSG information reporting action to a gateway, according to an exemplary embodiment of the present invention.

FIG. 11 is a flowchart illustrating a second exemplary embodiment of an updating process according to an exemplary embodiment of the present invention.

FIG. 12 is a flowchart illustrating a fourth exemplary embodiment of a handover process according to an exemplary embodiment of the present invention.

FIG. 13 is a flowchart illustrating a fifth exemplary embodiment of a handover process according to an exemplary embodiment of the present invention.

FIG. 14 is a flowchart illustrating a sixth exemplary embodiment of a handover process according to an exemplary embodiment of the present invention.

FIG. 15 is a flowchart illustrating a seventh exemplary embodiment of a handover process according to an exemplary embodiment of the present invention.

FIG. 16 is a flowchart illustrating an eighth exemplary embodiment of a handover process according to an exemplary embodiment of the present invention.

FIG. 17 is a flowchart illustrating a ninth exemplary embodiment of a handover process according to an exemplary embodiment of the present invention.

FIG. 18 is a block diagram of a small Base Station (BS) in a mobile communication system according to an exemplary embodiment of the present invention.

FIG. 19 is a block diagram of a gateway in a mobile communication system according to an exemplary embodiment of the present invention.

FIG. 20 is a block diagram of an MME in a mobile communication system according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

In view of the problems occurring in the related art, exemplary embodiments of the present invention include an apparatus and a method for a handover in a mobile communication system, which can have the handover terminated at a gateway, thereby reducing the processing loads exerted on the core network side and improving the handover efficiency.

The technical solutions of the exemplary embodiments of the present invention may be implemented as described herein.

(1) A Mobile Management Entity (MME) located in a core network determines whether the handover could be terminated at a gateway and transmits a determination result to the gateway. Upon receiving a message indicating the handover of a User Equipment (UE), the gateway implements the handover in a way of being terminated at the gateway if the determination result is that the handover could be terminated at the gateway, or the gateway implements the handover in a way of not being terminated at the gateway if the determination result is that the handover cannot be terminated at the gateway.

(2) An MME located in a core network transmits a UE location change reporting action and/or Closed Subscriber Group (CSG) information reporting action to a gateway. The gateway determines whether the handover could be terminated at the gateway from the content of the received UE location change reporting action /CSG information reporting action, and if yes, implements the handover in a way of being terminated at the gateway upon receiving a message indicating the handover of the UE, or otherwise, implements the handover in a way of not being terminated at the gateway when the UE requests the handover.

The technical solutions of the exemplary embodiments of the present invention are further described in detail hereinafter with reference to the accompanying drawings so as to make them more apparent.

It should be noted that in the exemplary embodiments described below, a scenario is taken as an example in which the UE is handed over among Home eNode Bs (HeNBs) in a Long Term Evolution (LTE) system and accordingly, the gateway is an HeNB GateWay (GW). The technical solutions of the exemplary embodiments of the present invention, however, also apply to a handover among Base Stations (BSs) in a 3^{rd} Generation (3G) network. In addition, if in the future, an eNode B (eNB) is also connected with the MME through a gateway or another radio resource management entity accesses the core network through a gateway, the technical solutions of the exemplary embodiments of the present invention also apply.

A particular implementation of method (1) is described below.

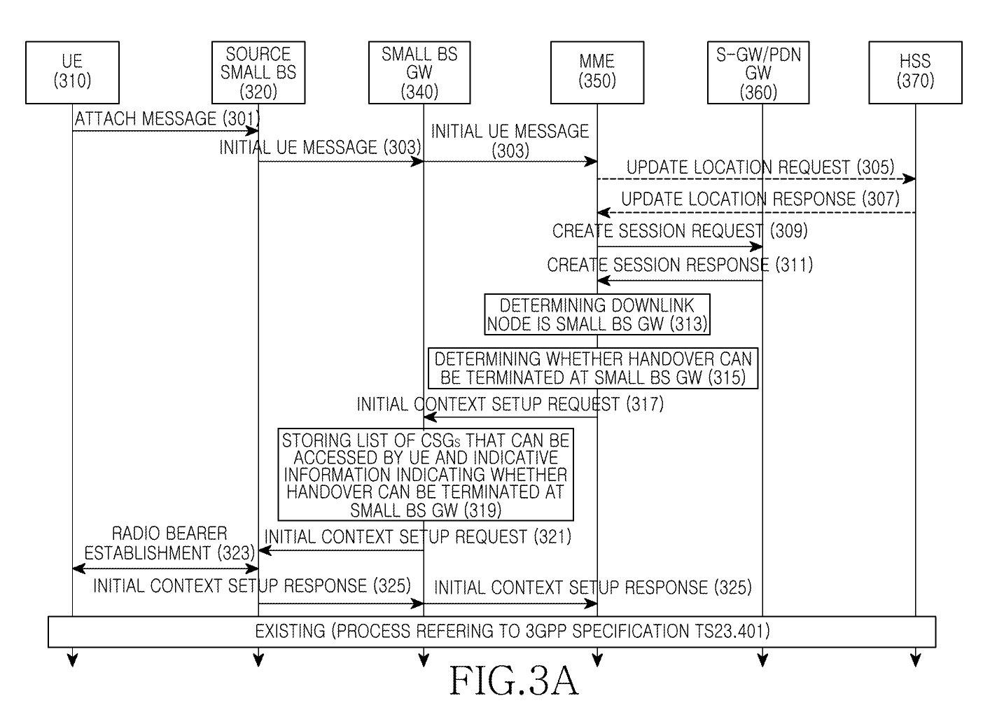

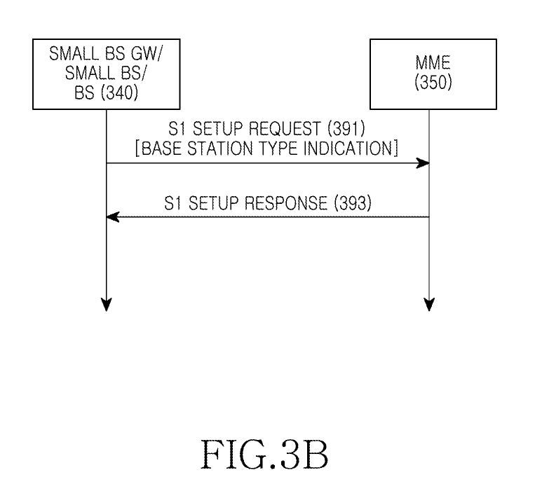

FIG. 3A is a flowchart illustrating a first exemplary embodiment in which an MME determines whether a handover could be terminated at a gateway and transmits a determination result to the gateway, according to an exemplary embodiment of the present invention. As illustrated in FIG. 3A, the exemplary embodiment includes the following steps.

Referring to FIG. 3A, in step 301, UE 310 transmits a Non-Access Stratum (NAS) message, such as an attach message, to a small BS 320. What information is particularly carried in the attach message is not related directly to the technical solution of the exemplary embodiments of the present invention and will not be described herein for conciseness in explanation.

In step 303, the small BS 320 transmits an S1 Access Protocol (S1AP) message, such as an initial UE message, to a small BS GW 340 and the small BS GW 340 further transmits an initial UE message to an MME 350. If the cell accessed by the UE 310 is of a CSG type or a hybrid type, a CSG identifier may be further carried in the initial UE message. The small BS 320 referred to here is the small BS 320 accessed by the UE 310.

In step 305, the MME 350 transmits an update location request message to a Home Subscriber Server (HSS) 370. If the MME 350 does not have valid UE subscription information, the current MME 350 is not the one to which the UE 310 was connected at the previous attach, i.e., the MME 350 is changed, or another condition is met, the MME 350 transmits an update location request message to the HSS 370. In step 307, the HSS 370 transmits an update location response message to the MME 350, with UE subscription information carried therein. The UE subscription information includes CSG subscription data, which in turn includes information such as the CSG which can be accessed by the UE 310 and validity time. As can be seen, only when a certain condition is met, i.e., the MME 350 does not have valid UE subscription information and so on, step 305 and thus step 307 will be performed. Therefore, steps 305 and 307 are optional.

In step 309, the MME 350 transmits a create session request message to a Serving GateWay/Packet Data Network GateWay (S-GW/PDN_GW) 360. The signaling interactions between the S-GW and the PDN GW are omitted here. In step 311, the S-GW/PDN_GW 360 transmits a create session response message to the MME 350. How the S-GW/PDN_GW 360 establishes a session is not related directly to the technical solution of the exemplary embodiments of the present invention and will not be described here for conciseness in explanation. In a practical application, a UE location change reporting action and/or CSG information reporting action may be further included in the create session response message. The content of the UE location change reporting action may be stopping reporting or one of the following, beginning to report a Cell Global Identifier (CGI)/Service Area Identifier (SAI), beginning to report an Evolved Cell Global Identifier (ECGI), beginning to report a Tracking Area Identifier (TAI), beginning to report a Routing Area Identifier (RAI), beginning to report an ECGI and a TAI, beginning to report a CGAI/SAI and a RAI, and so on. The content of the CSG information reporting action may be reporting or not reporting when the UE 310 enters/leaves/accesses a CSG cell, reporting or not reporting when the UE 310 enters/leaves/accesses a subscribed hybrid cell, and reporting or not reporting when the UE 310 enters/leaves/accesses an unsubscribed hybrid cell. Both the UE location change reporting action and the CSG information reporting action are included in the related art and thus a description thereof is omitted for conciseness in explanation. The MME 350 stores the UE location change reporting action and/or CSG information reporting action and performs corresponding operations.

In step 313, the MME 350 determines the downlink node is a small BS GW 340. The MME 350 determines the downlink node is a small BS GW 340 through the following methods. According to an exemplary embodiment of the present invention, before exchanging information, the MME 350 and the small BS GW 340 first perform an S1 setup process (which is included in the related art and thus a description thereof is omitted for conciseness in explanation), in which the small BS GW 340 transmits the identifier of itself, i.e., a small BS GW 340 identifier, to the MME 350 and the MME 350 determines the downlink node is a small BS GW 340 from the small BS GW 340 identifier. If the downlink node is an eNB or small BS 320, it may also be determined from its identifier. According to another exemplary embodiment of the present invention, in the S1 setup process, the small BS GW 340 transmits to the MME 350 an S1 setup request message, with a Tracking Area (TA) list supported by the small BS GW 340 carried therein. The TA list supported by the small BS GW 340 is a special one, from which the MME 350 can determine that the downlink node is a small BS GW 340. According to another exemplary embodiment of the present invention, in the S1 setup process, the small BS GW 340 has a BS type indication, indicating that the downlink node is a small BS GW 340, carried in an S1 setup request message transmitted to the MME 350, which is described in greater detail with reference to FIG. 3B.

FIG. 3B is a flowchart for indicating that a downlink node is a small BS GW in an S1 setup process according to an exemplary embodiment of the present invention.

Referring to FIG. 3B, in step 391, the small BS GW 340 transmits an S1 setup request message to the MME 350, with a BS type indication, indicating the downlink node is a small BS GW, carried therein. In step 393, the MME 350 transmits an S1 setup response message to the small BS GW 340. If the downlink node is a BS or small BS, the indication may be implemented similarly. The MME 350 may determine the downlink node is a small BS GW 340 through any of the above exemplary embodiments. These methods, however, are merely illustrative and are not limiting.

Returning to FIG. 3A, in step 315, the MME 350 determines whether the handover could be terminated at the small BS GW 340. In step 315, the MME 350 may determine whether the handover could be terminated at the small BS GW 340 from whether the UE location change reporting action and/or CSG information reporting action is received (in step 311) and the content of the UE location change reporting action and/or CSG information reporting action. For example, if the UE location change reporting action and the CSG information reporting action are not received, it is determined that the handover could be terminated at the small BS GW 340. If the UE location change reporting action is received and the content of the UE location change reporting action is stopping reporting, and/or, the CSG information reporting action is received and the content of the CSG information reporting action is not reporting when the UE 310 enters/leaves/accesses a CSG cell, not reporting when the UE 310 enters/leaves/accesses a subscribed hybrid cell, and not reporting when the UE 310 enters/leaves/accesses an unsubscribed hybrid cell, then it is determined that the handover could be terminated at the small BS GW 340. If the UE location change reporting action is received and the content of the UE location change reporting action is not stopping reporting, such as beginning to report an ECGI, and/or, the CSG information reporting action is received and the content of the CSG information reporting action is reporting when the UE 310 enters/leaves/accesses a CSG cell, reporting when the UE 310 enters/leaves/accesses a subscribed hybrid cell, and reporting when the UE 310 enters/leaves/accesses an unsubscribed hybrid cell, then it is determined that the handover cannot be terminated at the small BS GW 340.

In step 317, the MME 350 transmits to the small BS GW 340 an initial context setup request message, with a list of CSGs that can be accessed by the UE 310 and indicative information indicating whether the handover could be terminated at the small BS GW 340, carried therein. The list of CSGs that can be accessed by the UE 310 is obtained from the HSS 370. The MME 350 may transmit to the small BS GW 340 the indicative information indicating whether the handover could be terminated at the small BS GW 340, through the following methods, setting a special indicative bit in the initial context setup request message to be 1 or 0 to indicate whether the handover could be terminated at the small BS GW 340; or having the indicative bit carried when the handover could be terminated at the small BS GW 340, where the specific value of the indicative bit is not limited and it is deemed that the handover could be terminated at the small BS GW 340 so long as the indicative bit is present, and not having the indicative bit carried when the handover cannot be terminated at the small BS GW 340; or having the indicative bit carried when the handover cannot be terminated at the small BS GW 340, and not having the indicative bit carried when the handover could be terminated at the small BS GW 340. The specific implementation methods are not limited to those described herein.

In step 319, the small BS GW 340 stores the list of CSGs that can be accessed by the UE 310 and the indicative information indicating whether the handover could be terminated at the small BS GW 340. In step 321, the small BS GW 340 transmits an initial context setup request message to the small BS 320. Optionally, the indicative information indicating whether the handover could be terminated at the small BS GW 340 may be carried in the initial context setup request message. The small BS 320 may perform different handover flows depending on whether the handover could be terminated at the small BS GW 340. It is optional that the small BS GW 340 transmits the indicative information indicating whether the handover could be terminated at the small BS GW 340 to the small BS 320.

In addition, upon receiving the initial context setup request message transmitted from the MME 350, the small BS GW 340 may determine whether transmission of user plane data is implemented through one tunnel or two tunnels. One tunnel refers to the transmission of user plane data being implemented from the small BS 320 to the S-GW/PDN_GW 360 or from the S-GW/PDN_GW 360 to the small BS 320 directly. Two tunnels refers to the transmission of user plane data being implemented from the small BS 320 to the small BS GW 340 and then to the S-GW/PDN_GW 360 or from the S-GW/PDN_GW 360 to the small BS GW 340 and then to the small BS 320. For example, if the handover could be terminated at the small BS GW 340, two tunnels are employed. Alternatively, whether to employ one tunnel or two tunnels may be determined from the operator's configuration and so on.

When determining two tunnels are employed, the small BS GW 340 may assign an uplink tunnel identifier for each EAB and have the uplink tunnel identifier and the transport layer address of the small BS GW 340 carried in the initial context setup request message to the small BS 320, for establishing a user plane between the small BS 320 and the small BS GW 340. How to establish a user plane is included in the related art and thus is not described herein for conciseness in explanation. When determining one tunnel is employed, the small BS GW 340 has the uplink tunnel identifier and the transport layer address received from the MME 350 carried in the initial context setup request message to the small BS 320.

In step 323, the small BS 320 establishes the radio bearers with the UE 310. In step 325, the small BS 320 transmits an initial context setup response message to the small BS GW 340 and the small BS GW 340 transmits an initial context setup response message to the MME 350. When determining two tunnels are employed, the small BS GW 340 assigns a downlink tunnel identifier for each EAB and has the downlink tunnel identifier and the transport layer address of the small BS GW 340 carried in the initial context setup response message. When determining one tunnel is employed, the small BS GW 340 has the downlink tunnel identifier and the transport layer address received from the small BS 320 carried in the initial context setup response message.

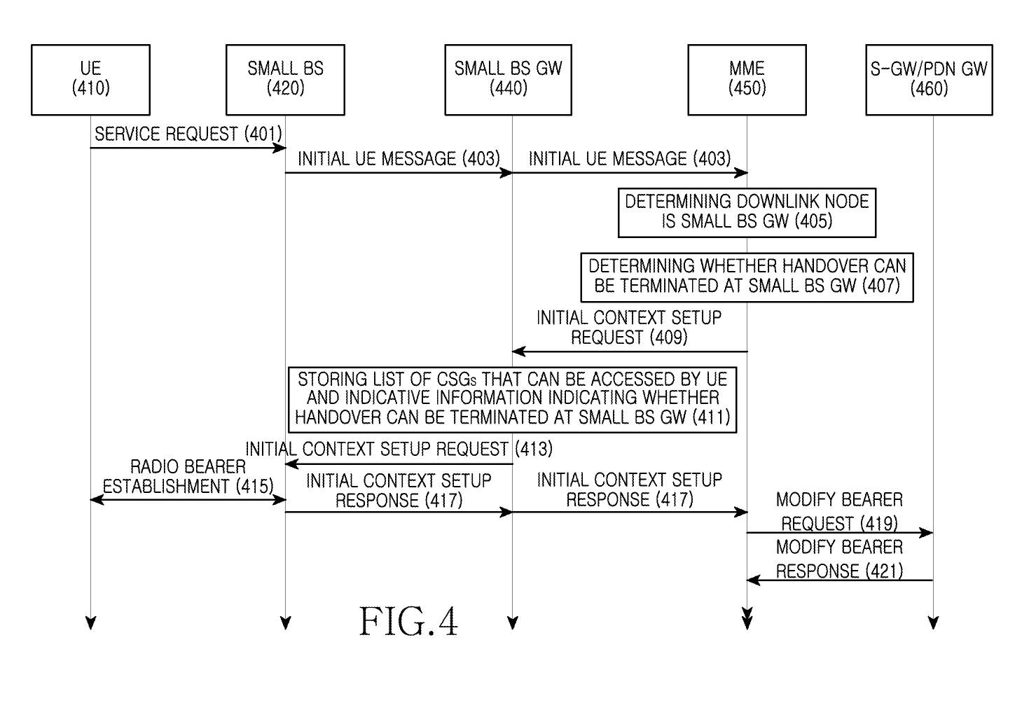

FIG. 4 is a flowchart illustrating a second exemplary embodiment in which an MME determines whether the handover could be terminated at a gateway and transmits a determination result to the gateway, according to an exemplary embodiment of the present invention.

Referring to FIG. 4, in step 401, UE 410 transmits an NAS message, such as a service request message, to a small BS 420. In step 403, the small BS 420 transmits an S1AP message, such as an initial UE message, to a small BS GW 440 and the small BS GW 440 further transmits an initial UE message to an MME 450.

In step 405, the MME 450 determines the downlink node is a small BS GW 440. The MME 450 determines the downlink node is a small BS GW 440 through the following methods. According to an exemplary embodiment of the present invention, before exchanging information, the MME 450 and the small BS GW 440 first perform an S1 setup process, in which the small BS GW 440 transmits the identifier of itself, i.e., a small BS GW 440 identifier, to the MME 450 and the MME 450 determines the downlink node is a small BS GW 440 from the small BS GW 440 identifier. If the downlink node is a BS or small BS 420, it may also be determined from its identifier. According to another exemplary embodiment of the present invention, in the S1 setup process, the small BS GW 440 transmits to the MME 450 an S1 setup request message, with a TA list supported by the small BS GW 440 carried therein. The TA list supported by the small BS GW 440 is a special one, from which the MME 450 can determine the downlink node is a small BS GW 440. According to another exemplary embodiment of the present invention, in the S1 setup process, the small BS GW 440 has a BS type indication, indicating the downlink node is a small BS GW 440, carried in an S1 setup request message transmitted to the MME 450.

In step 407, the MME 450 determines whether the handover could be terminated at the small BS GW 440. In this step, the MME 450 may determine whether the handover could be terminated at the small BS GW 440 from whether the UE location change reporting action and/or CSG information reporting action is received and the content of the UE location change reporting action and/or CSG information reporting action. For example, if the UE location change reporting action and the CSG information reporting action are not received, it is determined that the handover could be terminated at the small BS GW 440. If the UE location change reporting action is received and the content of the UE location change reporting action is stopping reporting, and/or, the CSG information reporting action is received and the content of the CSG information reporting action is not reporting when the UE 410 enters/leaves/accesses a CSG cell, not reporting when the UE 410 enters/leaves/accesses a subscribed hybrid cell, and not reporting when the UE 410 enters/leaves/accesses an unsubscribed hybrid cell, then it is determined that the handover could be terminated at the small BS GW 440. If the UE location change reporting action is received and the content of the UE location change reporting action is not stopping reporting, such as beginning to report an ECGI, and/or, the CSG information reporting action is received and the content of the CSG information reporting action is reporting when the UE 410 enters/leaves/accesses a CSG cell, reporting when the UE 410 enters/leaves/accesses a subscribed hybrid cell, and reporting when the UE 410 enters/leaves/accesses an unsubscribed hybrid cell, then it is determined that the handover cannot be terminated at the small BS GW 440.

In step 409, the MME 450 transmits to the small BS GW 440 an initial context setup request message, with a list of CSGs that can be accessed by the UE 410 and indicative information indicating whether the handover could be terminated at the small BS GW 440, carried therein. The list of CSGs that can be accessed by the UE 410 is obtained from an HSS. The MME 450 may transmit to the small BS GW 440 the indicative information indicating whether the handover could be terminated at the small BS GW 440, through the following methods, setting a special indicative bit in the initial context setup request message to be 1 or 0 to indicate whether the handover could be terminated at the small BS GW 440; or having the indicative bit carried when the handover could be terminated at the small BS GW 440, where the specific value of the indicative bit is not limited and it is deemed that the handover could be terminated at the small BS GW 440 so long as the indicative bit is present, and not having the indicative bit carried when the handover cannot be terminated at the small BS GW 440; or having the indicative bit carried when the handover cannot be terminated at the small BS GW 440, and not having the indicative bit carried when the handover could be terminated at the small BS GW 440. The specific implementation methods are not limited to those described herein.

In step 411, the small BS GW 440 stores the list of CSGs that can be accessed by the UE 410 and the indicative information indicating whether the handover could be terminated at the small BS GW 440. In step 413, the small BS GW 440 transmits an initial context setup request message to the small BS 420. Optionally, the indicative information indicating whether the handover could be terminated at the small BS GW 440 may be carried in the initial context setup request message. The small BS 420 may perform different handover flows depending on whether the handover could be terminated at the small BS GW 440. It is optional that the small BS GW 440 transmits the indicative information indicating whether the handover could be terminated at the small BS GW 440 to the small BS 420.

In addition, upon receiving the initial context setup request message transmitted from the MME 450, the small BS GW 440 may determine whether transmission of user plane data is implemented through one tunnel or two tunnels. One tunnel refers to the transmission of user plane data being implemented from the small BS 420 to the S-GW/PDN_GW 460 or from the S-GW/PDN_GW 460 to the small BS 420 directly. Two tunnels refers to the transmission of user plane data being implemented from the small BS 420 to the small BS GW 440 and then to the S-GW/PDN_GW 460 or from the S-GW/PDN_GW 460 to the small BS GW 440 and then to the small BS 420. For example, if the handover could be terminated at the small BS GW 440, two tunnels are employed. Alternatively, whether to employ one tunnel or two tunnels may be determined from the operator's configuration and so on.

When determining two tunnels are employed, the small BS GW 440 may assign an uplink tunnel identifier for each EAB and have the uplink tunnel identifier and the transport layer address of the small BS GW 440 carried in the initial context setup request message to the small BS 420, for establishing a user plane between the small BS 420 and the small BS GW 440. How to establish a user plane is included in the related art and thus a description thereof is omitted for conciseness in explanation. When determining one tunnel is employed, the small BS GW 440 has the uplink tunnel identifier and the transport layer address received from the MME 450 carried in the initial context setup request message to the small BS 420.

In step 415, the small BS 420 establishes the radio bearers with the UE 410. In step 417, the small BS 420 transmits an initial context setup response message to the small BS GW 440 and the small BS GW 440 transmits an initial context setup response message to the MME 450. When determining two tunnels are employed, the small BS GW 440 assigns a downlink tunnel identifier for each EAB and has the downlink tunnel identifier and the transport layer address of the small BS GW 440 carried in the initial context setup response message. When determining one tunnel is employed, the small BS GW 440 has the downlink tunnel identifier and the transport layer address received from the small BS 420 carried in the initial context setup response message.

In step 419, the MME 450 transmits a modify bearer request message to the S-GW/PDN GW 460. If the MME 450 has stored the UE location change reporting action and/or CSG information reporting action (because the UE 410 transmits a service request message indicating that the attach process has been completed, it is possible for the MME 450 to receive the UE location change reporting action and/or CSG information reporting action), and the current status meets the reporting condition, then the information to be reported is further carried in the modify bearer request message.

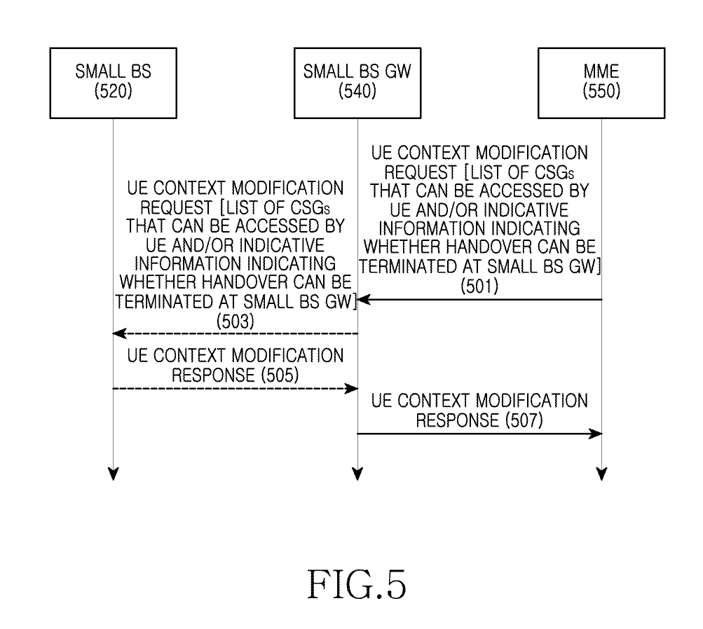

In step 421, the S-GW/PDN_GW 460 transmits a modify bearer response message to the MME 450. The S-GW/PDN_GW 460 may have the UE location change reporting action and/or CSG information reporting action carried in the modify bearer response message. If the UE location change reporting action and the CSG information reporting action have not been received in the previous attach process but are received now; or if the UE location change reporting action and/or CSG information reporting action has been received in the previous attach process but is not received now; or if the UE location change reporting action and/or CSG information reporting action received in the previous attach process is not the same as that received in this step, then the MME 450 may re-determine whether the handover could be terminated at the small BS GW 440. The specific implementations are substantially the same as those of step 407 and thus a description thereof is omitted for conciseness in explanation. If the result of the re-determination is different from that of step 407, the MME 450 may update the indicative information stored in the small BS GW 440 indicating whether the handover could be terminated at the small BS GW 440, according to a process as illustrated in FIG. 5. Moreover, if the list of CSGs that can be accessed by the UE 410 changes, it also should be updated.

FIG. 5 is a flowchart illustrating a first exemplary embodiment of an updating process according to an exemplary embodiment of the present invention.

Referring to FIG. 5, in step 501, the MME 550 updates the list of CSGs that can be accessed by the UE and/or the determination result as to whether the handover could be terminated at the small BS GW 540, and transmits a UE context modification request message to the small BS GW 540.

If one or both of the following conditions are met, 1) the MME 550 becomes aware through an HSS that the list of CSGs that can be accessed by the UE changes; 2) the MME 550 updates the determination result as to whether the handover could be terminated at the small BS GW 540 according to the content of the UE location change reporting action and/or CSG information reporting action and so on, the MME 550 transmits a UE context modification request message to the small BS GW 540, with the list of CSGs that can be accessed by the UE and/or the indicative information indicating whether the handover could be terminated at the small BS GW 540, carried therein. The specific method of carrying the indicative information is substantially the same as that described above for step 309 of FIG. 3.

In step 503, the small BS GW 540 transmits to the small BS 520 a UE context modification request message, with the indicative information indicating whether the handover could be terminated at the small BS GW 540 carried therein. The UE context modification request message may also have the list of CSGs that can be accessed by the UE carried therein. In step 505, the small BS 520 transmits a UE context modification response message to the small BS GW 540. Steps 503 and 505 may be omitted. In step 507, the small BS GW 540 transmits a UE context modification response message to the MME 550.

How to determine whether the handover could be terminated at the gateway and how to update the determination result and the list of CSGs that can be accessed by the UE, have been described with reference to the above three exemplary embodiments. How to implement the handover will be described below.

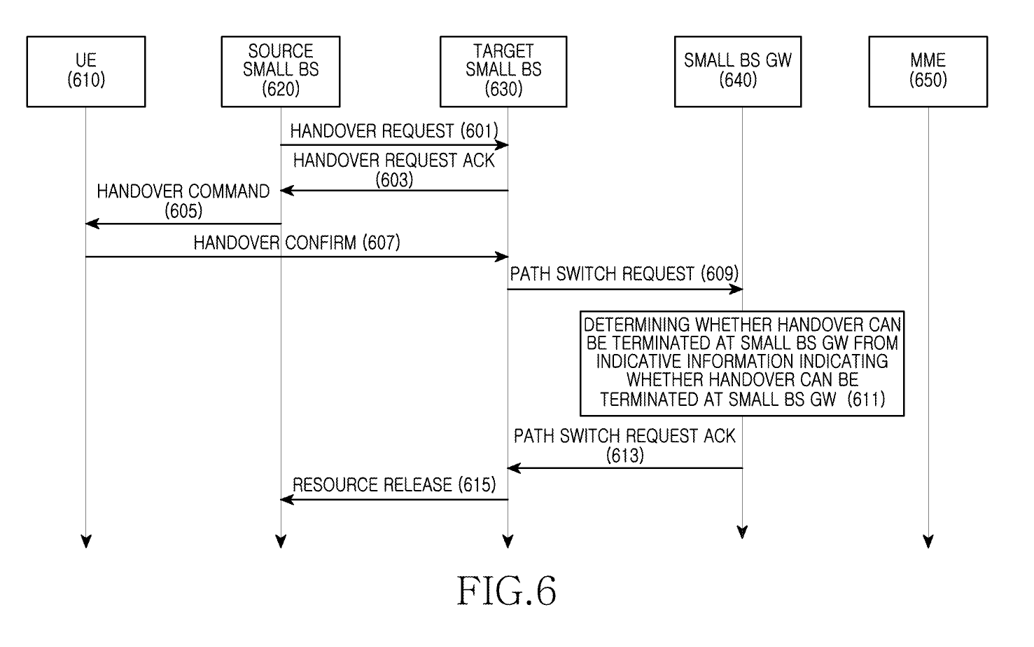

FIG. 6 is a flowchart illustrating a first exemplary embodiment of a handover process according to an exemplary embodiment of the present invention.

Referring to FIG. 6, in step 601, the source small BS 620 transmits a handover request message to the target small BS 630. In a practical application, if the target cell to which the UE 610 is to be handed over is of a CSG type, and the CSG identifier of the target cell is different from the CSG identifier of the source cell serving the UE 610 (including the case in which the source cell is not of a CSG type), an access control on the UE 610 should be implemented, i.e., to determine whether the UE 610 can access the target cell. If not, the handover fails. Whether the UE 610 can access the target cell can be determined by determining whether the CSG identifier of the target cell is included in the list of accessible CSGs. If the target cell is of hybrid type, it also should implement an access control, i.e., to determine whether the UE 610 is a CSG member of the target cell and different Qualities of Service (QoS) are provided depending on the determination result. Whether the UE 610 is a member can be determined based on the list of accessible CSGs. If the source cell and target cell are in the same CSG, no access control needs to be implemented.

The access control may be implemented in the source small BS 620, the small BS GW 640 or the target small BS 630. If in the source or target small BS 630, the CSG identifier of the target cell and the list of CSGs that can be accessed by the UE 610 should be transmitted to the source or target small BS 630. How to obtain the CSG identifier of the target cell is included in the related art and thus a description thereof is omitted for conciseness in explanation. The methods in which the source small BS 620 and the small BS GW 640 obtain the list of CSGs that can be accessed by the UE 610 have been described in the previous exemplary embodiments and thus will not be repeated here for conciseness in explanation. The source small BS 620 may transmit the list of CSGs that can be accessed by the UE 610 to the target small BS 630 through the handover request message in this step.

In step 603, the target small BS 630 allocates resources for the UE 610 and transmits a handover request acknowledge message to the source small BS 620. In step 605, the source small BS 620 transmits a handover command message to the UE 610. In step 607, the UE 610 transmits a handover confirm message to the target small BS 630. In step 609, the target small BS 630 transmits a path switch request message to the small BS GW 640.

In step 611, the small BS GW 640 determines whether the handover could be terminated at the small BS GW 640 from the indicative information indicating whether the handover could be terminated at the small BS GW 640. If the handover could be terminated at the small BS GW 640, step 613 is performed. The small BS GW 640 may determine whether the handover could be terminated at the small BS GW 640 simply from the indicative information. In addition, the small BS GW 640 may determine whether the handover could be terminated at the small BS GW 640, with other information, such as the operator's configuration and whether the transmission of user plane data is implemented through one tunnel or two tunnels, which is taken into account in combination.

For example, if the indicative information indicates that the handover cannot be terminated at the small BS GW 640, it is deemed that the handover cannot be terminated at the small BS GW 640 and the handover is implemented where the handover is terminated at an MME 660. If the indicative information indicates that the handover could be terminated at the small BS GW 640, it is deemed that the handover could be terminated at the small BS GW 640 and step 613 is performed subsequently. Alternatively, if the indicative information indicating whether the handover could be terminated at the small BS GW 640 indicates that the handover could be terminated at the small BS GW 640, but the operator's configuration and so on indicate that the handover cannot be terminated at the small BS GW 640, it is deemed that the handover cannot be terminated at the small BS GW 640 and the handover is implemented where the handover is terminated at an MME 660. Alternatively, if the indicative information indicating whether the handover could be terminated at the small BS GW 640 indicates that the handover could be terminated at the small BS GW 640, but the transmission of user plane data is implemented through one tunnel, it is deemed that the handover cannot be terminated at the small BS GW 640 and the handover is implemented where the handover is terminated at an MME 660.

In step 613, the small BS GW 640 transmits a path switch request acknowledge (ACK) message to the target small BS 630. In step 615, the target small BS 630 transmits a resource release message to the source small BS 620.

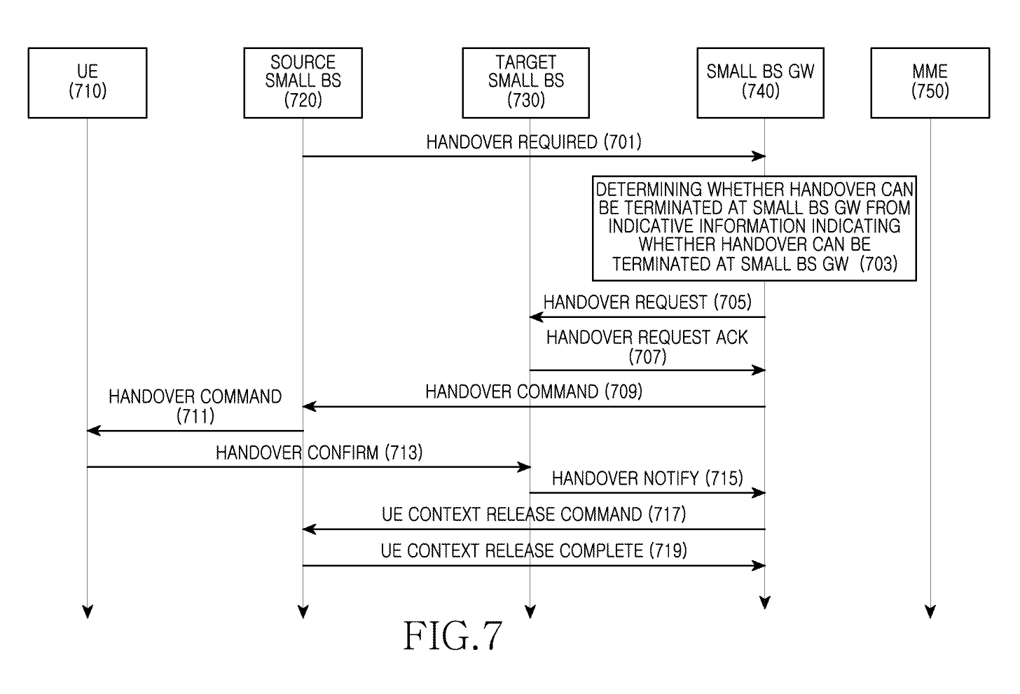

FIG. 7 is a flowchart illustrating a second exemplary embodiment of a handover process according to an exemplary embodiment of the present invention.

Referring to FIG. 7, in step 701, the source small BS 720 transmits a handover required message to the small BS GW 740.

In step 703, the small BS GW 740 determines whether the handover could be terminated at the small BS GW 740 from the indicative information indicating whether the handover could be terminated at the small BS GW 740. If yes, step 705 is performed. The small BS GW 740 may determine whether the handover could be terminated at the small BS GW 740 simply from the indicative information. In addition, the small BS GW 740 may determine whether the handover could be terminated at the small BS GW 740, with other information, such as the operator's configuration and whether the transmission of user plane data is implemented through one tunnel or two tunnels, which is taken into account in combination. For example, if the indicative information indicates that the handover cannot be terminated at the small BS GW 740, it is deemed that the handover cannot be terminated at the small BS GW 740 and the handover is implemented where the handover is terminated at an MME 750. If the indicative information indicates that the handover could be terminated at the small BS GW 740, it is deemed that the handover could be terminated at the small BS GW 740 and step 713 is performed subsequently. Alternatively, if the indicative information indicating whether the handover could be terminated at the small BS GW 740 indicates that the handover could be terminated at the small BS GW 740, but the operator's configuration and so on indicate that the handover cannot be terminated at the small BS GW 740, it is deemed that the handover cannot be terminated at the small BS GW 740 and the handover is implemented where the handover is terminated at an MME 750. Alternatively, if the indicative information indicating whether the handover could be terminated at the small BS GW 740 indicates that the handover could be terminated at the small BS GW 740, but the transmission of user plane data is implemented through one tunnel, it is deemed that the handover cannot be terminated at the small BS GW 740 and the handover is implemented where the handover is terminated at an MME 750.

In step 705, the small BS GW 740 transmits a handover request message to the target small BS 730. In step 707, the target small BS 730 allocates resources for the UE 710 and transmits a handover request acknowledge message to the small BS GW 740. In step 709, the small BS GW 740 transmits a handover command message to the source small BS 720. In step 711, the source small BS 720 transmits a handover command message to the UE 710. In step 713, the UE 710 transmits a handover confirm message to the target small BS 730. In step 715, the target small BS 730 transmits a handover notify message to the small BS GW 740. In step 717, the small BS GW 740 transmits a UE context release command message to the source small BS 720. In step 719, the source small BS 720 transmits a UE context release complete message to the small BS GW 740.

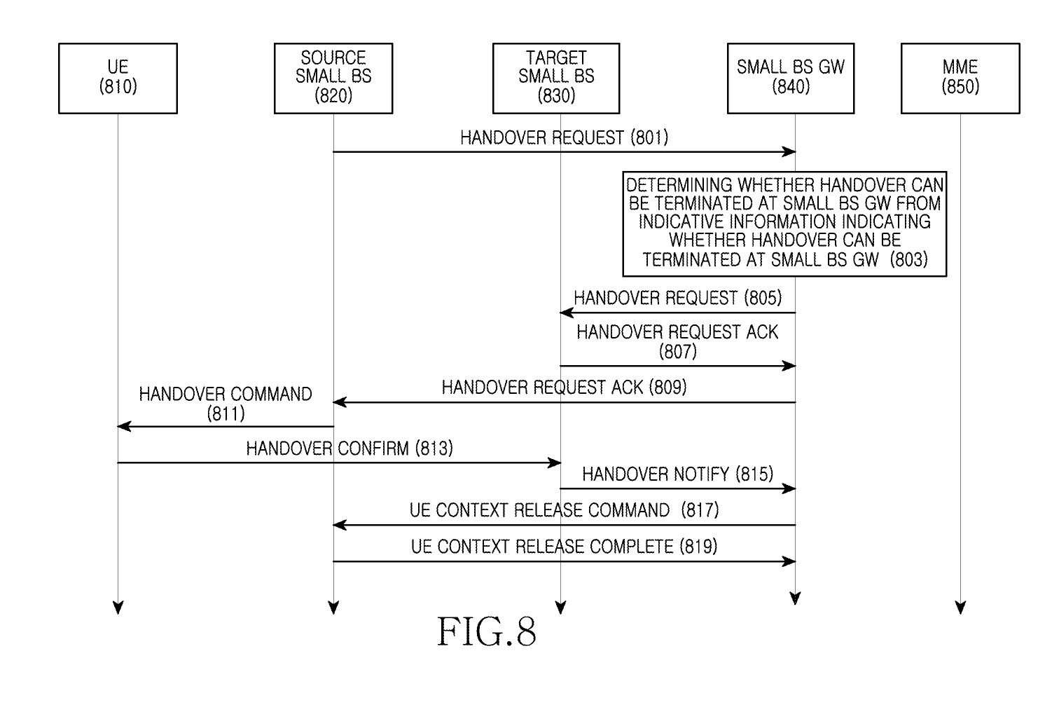

FIG. 8 is a flowchart illustrating a third exemplary embodiment of a handover process according to an exemplary embodiment of the present invention.

Referring to FIG. 8, in step 801, the source small BS 820 transmits a handover request message to the small BS GW 840.

In step 803, the small BS GW 840 determines whether the handover could be terminated at the small BS GW 840 from the indicative information indicating whether the handover could be terminated at the small BS GW 840. If the handover could be terminated at the small BS GW 840, step 805 is performed. The small BS GW 840 may determine whether the handover could be terminated at the small BS GW 840 simply from the indicative information. In addition, the small BS GW 840 may determine whether the handover could be terminated at the small BS GW 840, with other information, such as the operator's configuration and whether the transmission of user plane data is implemented through one tunnel or two tunnels, which is taken into account in combination. For example, if the indicative information indicates that the handover cannot be terminated at the small BS GW 840, it is deemed that the handover cannot be terminated at the small BS GW 840 and the handover is implemented where the handover is terminated at an MME 860. If the indicative information indicates that the handover could be terminated at the small BS GW 840, it is deemed that the handover could be terminated at the small BS GW 840 and step 813 is performed subsequently. Alternatively, if the indicative information indicating whether the handover could be terminated at the small BS GW 840 indicates that the handover could be terminated at the small BS GW 840, but the operator's configuration and so on indicate that the handover cannot be terminated at the small BS GW 840, it is deemed that the handover cannot be terminated at the small BS GW 840 and the handover is implemented where the handover is terminated at an MME 860. Alternatively, if the indicative information indicating whether the handover could be terminated at the small BS GW 840 indicates that the handover could be terminated at the small BS GW 840, but the transmission of user plane data is implemented through one tunnel, it is deemed that the handover cannot be terminated at the small BS GW 840 and the handover is implemented where the handover is terminated at an MME 860.

In step 805, the small BS GW 840 transmits a handover request message to the target small BS 830. As illustrated in FIG. 7, in steps 701 and 705, the small BSs exchange information with the small BS GW through S1 interfaces. However, in steps 801 and 805, the small BSs exchange information with the small BS GW 840 through X2 interfaces, where in step 801, the source small BS 820 transmits an X2 Access Protocol (X2AP) message i.e., a handover request message to the small BS GW 840, and, in step 805, the small BS GW 840 transmits an X2AP handover request message to the target small BS 830.

In step 807, the target small BS 830 allocates resources for the UE 810 and transmits a handover request acknowledge message to the small BS GW 840. In step 809, the small BS GW 840 transmits a handover request acknowledge message to the source small BS 820. As illustrated in FIG. 7, in steps 707 and 709, the small BSs exchange information with the small BS GW through S1 interfaces. However, in steps 807 and 809, the small BSs exchange information with the small BS GW 840 through X2 interfaces, where in step 807, the target small BS 830 transmits an X2AP handover request acknowledge message to the small BS GW 840 and in step 809, the small BS GW 840 transmits an X2AP handover request acknowledge message to the source small BS 820.

In step 811, the source small BS 820 transmits a handover command message to the UE 810. In step 813, the UE 810 transmits a handover confirm message to the target small BS 830. In step 815, the target small BS 830 transmits a handover notify message to the small BS GW 840. In this step, the target small BS 830 transmits a handover notify message to the small BS GW 840 through an S1 interface. Alternatively, an X2 interface may be used so that the target small BS 830 transmits a path switch request message to the small BS GW 840 and the small BS GW 840 returns a path switch request acknowledge message to the target small BS 830.

In step 817, the small BS GW 840 transmits a UE context release command message to the source small BS 820. In step 819, the source small BS 820 transmits a UE context release complete message to the small BS GW 840. In steps 817 and 819, an S1 interface is used between the small BS GW 840 and the source small BS 820. Alternatively, an X2 interface may be used so that the target small BS 830 transmits a resource release message to the small BS GW 840 and the small BS GW 840 transmits a resource release message to the source small BS 820.

Implementation (1) of the technical solution of exemplary embodiments of the present invention has been described above Implementation (2) of the technical solution of exemplary embodiments the present invention will be further described below.

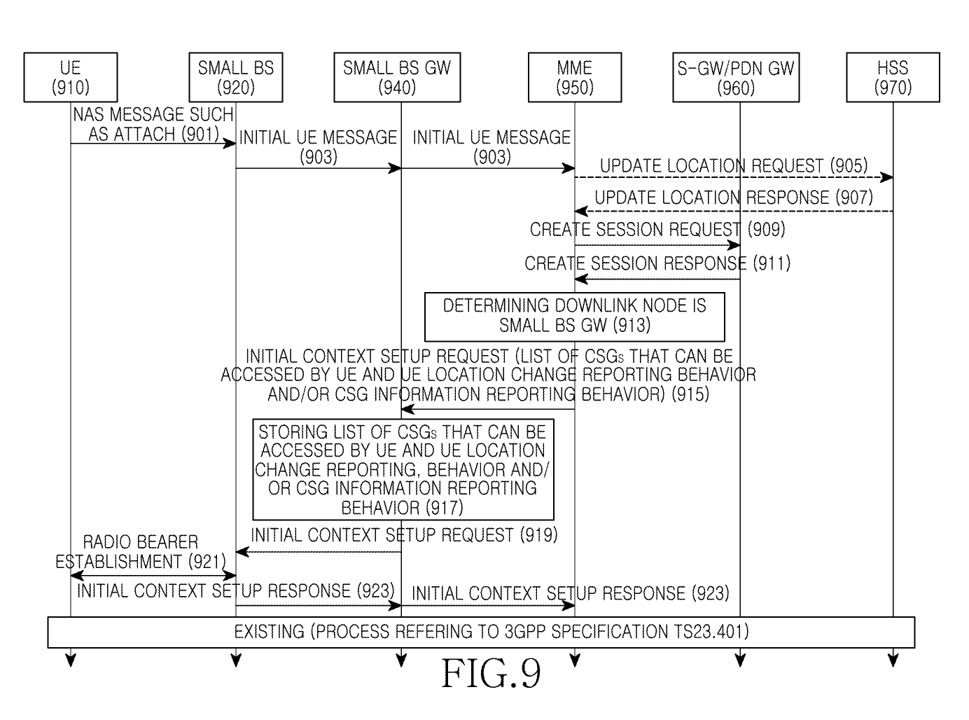

FIG. 9 is a flowchart illustrating a first exemplary embodiment in which an MME transmits a UE location change reporting action and/or CSG information reporting action to a gateway, according to an exemplary embodiment of the present invention.

Referring to FIG. 9, in step 901, UE 910 transmits a Non-Access Stratum (NAS) message, such as an attach message, to a small BS 920. What information is particularly carried in the attach message is not related directly to the technical solution of exemplary embodiments of the present invention and will not be described here for conciseness in explanation.

In step 903, the small BS 920 transmits an S1 Access Protocol (S1AP) message, such as an initial UE message, to a small BS GW 940 and the small BS GW 940 further transmits an initial UE message to an MME 950. If the cell accessed by the UE 910 is of a CSG type or hybrid type, a CSG identifier may be further carried in the initial UE message. The small BS 920 referred to here is the small BS 920 accessed by the UE 910.

In step 905, the MME 950 transmits an update location request message to a Home Subscriber Server (HSS) 970. If the MME 950 does not have valid UE subscription information, the current MME 950 is not the one to which the UE 910 was connected at the previous attach, i.e., the MME 950 is changed, or another condition is met, the MME 950 transmits an update location request message to the HSS 970. In step 907, the HSS 970 transmits an update location response message to the MME 950, with UE subscription information carried therein. The UE subscription information includes CSG subscription data, which in turn includes information such as the CSG which can be accessed by the UE 910 and validity time. As can be seen, only when a certain condition is met, i.e., the MME 950 does not have valid UE subscription information and so on, step 905 and thus step 907 will be performed. Therefore, steps 905 and 907 are optional.

In step 909, the MME 950 transmits a create session request message to an S-GW/PDN_GW 960. The signaling interactions between the S-GW and the PDN GW are omitted here for conciseness in explanation. In step 911, the S-GW/PDN_GW 960 transmits a create session response message to the MME 950. How the S-GW/PDN_GW 960 establishes a session is not related directly to the technical solution of the exemplary embodiments of the present invention and will not be described here for conciseness in explanation. In a practical application, a UE location change reporting action and/or CSG information reporting action may be further included in the create session response message. The content of the UE location change reporting action may be stopping reporting or one of the following, beginning to report a CGI/SAI, beginning to report an ECGI, beginning to report a TAI, beginning to report an RAI, beginning to report an ECGI and a TAI, beginning to report a CGAI/SAI and a RAI, and so on. The content of the CSG information reporting action may be reporting or not reporting when the UE 910 enters/leaves/accesses a CSG cell, reporting or not reporting when the UE 910 enters/leaves/accesses a subscribed hybrid cell, and reporting or not reporting when the UE 910 enters/leaves/accesses an unsubscribed hybrid cell. Both the UE location change reporting action and the CSG information reporting action are included in the related art and thus a description thereof is omitted for conciseness in explanation. The MME 950 stores the UE location change reporting action and/or CSG information reporting action and performs corresponding operations.

In step 913, the MME 950 determines the downlink node is a small BS GW 940. The MME 950 may determine the downlink node is a small BS GW 940 through the following methods. According to an exemplary embodiment of the present invention, before exchanging information, the MME 950 and the small BS GW 940 first perform an S1 setup process (which is included in the related art and thus a description thereof is omitted for conciseness in explanation), in which the small BS GW 940 transmits the identifier of itself, i.e., a small BS GW 940 identifier, to the MME 950 and the MME 950 determines the downlink node is a small BS GW 940 from the small BS GW 940 identifier. If the downlink node is an eNB or small BS 920, it may also be determined from its identifier. According to another exemplary embodiment of the present invention, in the S1 setup process, the small BS GW 940 transmits to the MME 950 an S1 setup request message, with a TA list supported by the small BS GW 940 carried therein. The TA list supported by the small BS GW 940 is a special one, from which the MME 950 can determine the downlink node is a small BS GW 940. According to another exemplary embodiment of the present invention, in the S1 setup process, the small BS GW 940 has a BS type indication, indicating the downlink node is a small BS GW 940, carried in an S1 setup request message transmitted to the MME 950. Herein, the technique for indicating that the downlink node is a small BS GW in an S1 setup process is substantially the same technique described above with reference to FIG. 3B and thus a description thereof it omitted herein for conciseness in explanation.

In step 915, the MME 950 transmits to the small BS GW 940 an initial context setup request message, with a list of CSGs that can be accessed by the UE 910 and a UE location change reporting action and/or CSG information reporting action carried therein. The UE location change reporting action and/or CSG information reporting action may be the same as those received from the S-GW/PDN GW, i.e., in step 909, or may be those filtered by the MME, e.g., only those related to the LTE technology. For example, the content of the UE location change reporting action may be stopping reporting or one of the following, beginning to report an ECGI, beginning to report a TAI, beginning to report an ECGI and a TAI, and so on.

In step 917, the small BS GW 940 stores the received list of CSGs that can be accessed by the UE 910 and the UE location change reporting action and/or CSG information reporting action. In step 919, the small BS GW 940 transmits an initial context setup request message to the small BS 920. Optionally, the list of CSGs that can be accessed by the UE 910 and the UE location change reporting action and/or CSG information reporting action may be carried in the initial context setup request message.

In addition, the small BS GW 940 may also determine whether transmission of user plane data is implemented through one tunnel or two tunnels. For example, if the small BS GW 940 determines that the handover could be terminated at the small BS GW 940, two channels are employed. Alternatively, whether to employ one tunnel or two tunnels may be determined from the operator's configuration and so on. When determining two tunnels are employed, the small BS GW 940 may assign an uplink tunnel identifier for each EAB and have the uplink tunnel identifier and the transport layer address of the small BS GW 940 carried in the initial context setup request message to the small BS 920, for establishing a user plane between the small BS 920 and the small BS GW 940. How to establish a user plane is included in the related art and thus a description thereof is omitted for conciseness in explanation. When determining one tunnel is employed, the small BS GW 940 has the uplink tunnel identifier and the transport layer address received from the MME 950 carried in the initial context setup request message to the small BS 920.

In step 921, the small BS 920 establishes the radio bearers with the UE 910. In step 923, the small BS 920 transmits an initial context setup response message to the small BS GW 940 and the small BS GW 940 transmits an initial context setup response message to the MME 950. When determining two tunnels are employed, the small BS GW 940 assigns a downlink tunnel identifier for each EAB and has the downlink tunnel identifier and the transport layer address of the small BS GW 940 carried in the initial context setup response message. When determining one tunnel is employed, the small BS GW 940 has the downlink tunnel identifier and the transport layer address received from the small BS 920 carried in the initial context setup response message.

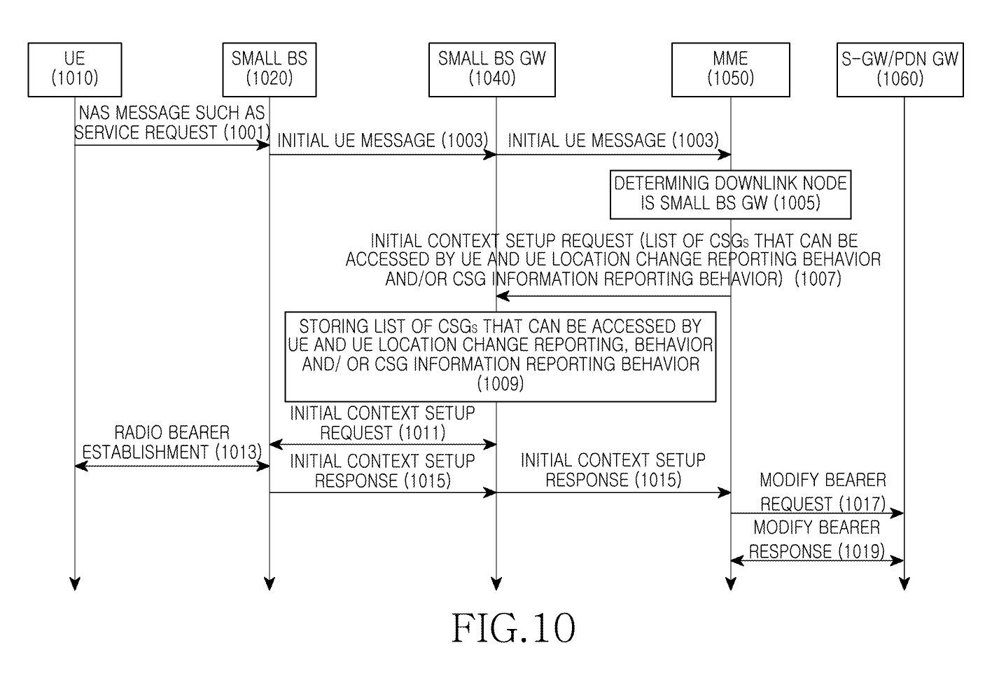

FIG. 10 is a flowchart illustrating a second exemplary embodiment in which an MME transmits a UE location change reporting action and/or CSG information reporting action to a gateway, according to an exemplary embodiment of the present invention.

Referring to FIG. 10, in step 1001, UE 1010 transmits an NAS message, such as a service request message, to a small BS 1020. In step 1003, the small BS 1020 transmits an S1AP message, such as an initial UE message, to a small BS GW 1040 and the small BS GW 1040 further transmits an initial UE message to an MME 1050.

In step 1005, the MME 1050 determines the downlink node is a small BS GW 1040. The MME 1050 may determine the downlink node is a small BS GW 1040 through the following methods. According to an exemplary embodiment of the present invention, before exchanging information, the MME 1050 and the small BS GW 1040 first perform an S1 setup process, in which the small BS GW 1040 transmits the identifier of itself, i.e., a small BS GW 1040 identifier, to the MME 1050 and the MME 1050 determines the downlink node is a small BS GW 1040 from the small BS GW 1040 identifier. If the downlink node is a BS or small BS 1020, it may also be determined from its identifier. According to another exemplary embodiment of the present invention, in the S1 setup process, the small BS GW 1040 transmits to the MME 1050 an S1 setup request message, with a TA list supported by the small BS GW 1040 carried therein. The TA list supported by the small BS GW 1040 is a special one, from which the MME 1050 can determine the downlink node is a small BS GW 1040. According to another exemplary embodiment of the present invention, in the S1 setup process, the small BS GW 1040 has a BS type indication, indicating the downlink node is a small BS GW 1040, carried in an S1 setup request message transmitted to the MME 1050.

In step 1007, the MME 1050 transmits to the small BS GW 1040 an initial context setup request message, with a list of CSGs that can be accessed by the UE 1010 and a UE location change reporting action and/or CSG information reporting action carried therein. The UE location change reporting action and/or CSG information reporting action may be the same as those received from the S-GW/PDN GW, i.e., in step 1009, or may be those filtered by the MME, e.g., only those related to the LTE technology. For example, the content of the UE location change reporting action may be stopping reporting or one of the following, beginning to report an ECGI, beginning to report a TAI, beginning to report an ECGI and a TAI, and so on.

In step 1009, the small BS GW 1040 stores the received list of CSGs that can be accessed by the UE 1010 and the UE location change reporting action and/or CSG information reporting action. In step 1011, the small BS GW 1040 transmits an initial context setup request message to the small BS 1020. Optionally, the list of CSGs that can be accessed by the UE 1010 and the UE location change reporting action and/or CSG information reporting action may be carried in the initial context setup request message.

In addition, the small BS GW 1040 may determine whether transmission of user plane data is implemented through one tunnel or two tunnels. For example, if the small BS GW 1040 determines that the handover could be terminated at the small BS GW 1040, two channels are employed. Alternatively, whether to employ one tunnel or two tunnels may be determined from the operator's configuration and so on. When determining two tunnels are employed, the small BS GW 1040 may assign an uplink tunnel identifier for each EAB and have the uplink tunnel identifier and the transport layer address of the small BS GW 1040 carried in the initial context setup request message to the small BS 1020, for establishing a user plane between the small BS 1020 and the small BS GW 1040. How to establish a user plane is included in the related art and thus a description thereof is omitted for conciseness in explanation. When determining one tunnel is employed, the small BS GW 1040 has the uplink tunnel identifier and the transport layer address received from the MME 1050 carried in the initial context setup request message to the small BS 1020.

In step 1013, the small BS 1020 establishes the radio bearers with the UE 1010. In step 1015, the small BS 1020 transmits an initial context setup response message to the small BS GW 1040 and the small BS GW 1040 transmits an initial context setup response message to the MME 1050. When determining two tunnels are employed, the small BS GW 1040 assigns a downlink tunnel identifier for each EAB and has the downlink tunnel identifier and the transport layer address of the small BS GW 1040 carried in the initial context setup response message. When determining one tunnel is employed, the small BS GW 1040 has the downlink tunnel identifier and the transport layer address received from the small BS 1020 carried in the initial context setup response message.

In step 1017, the MME 1050 transmits a modify bearer request message to the S-GW/PDN_GW 1060. If the MME 1050 has stored the UE location change reporting action and/or CSG information reporting action (because the UE 1010 transmits a service request message indicating that the attach process has been completed, it is possible for the MME 1050 to receive the UE location change reporting action and/or CSG information reporting action), and the current status meets the reporting condition, then the information to be reported is further carried in the modify bearer request message.

In step 1019, the S-GW/PDN_GW 1060 transmits a modify bearer response message to the MME 1050. The S-GW/PDN_GW 1060 may have the UE location change reporting action and/or CSG information reporting action carried in the modify bearer response message. If the UE location change reporting action and the CSG information reporting action have not been received in the previous attach process but are received now; or if the UE location change reporting action and/or CSG information reporting action has been received in the previous attach process but is not received now; or if the UE location change reporting action and/or CSG information reporting action received in the previous attach process is not the same as that received in this step, then the MME 1050 may re-provide the UE location change reporting action and/or CSG information reporting action to the small BS GW 1040. Moreover, if the list of CSGs that can be accessed by the UE 1010 changes, it also should be re-provided.

The exemplary embodiments as illustrated in FIGS. 9 and 10 describe how the MME transmits the UE location change reporting action and/or CSG information reporting action to the small BS GW. Afterwards, if the UE location change reporting action and/or CSG information reporting action is changed, the MME also needs to update the UE location change reporting action and/or CSG information reporting action transmitted to the small BS GW previously. In addition, if the list of CSGs that can be accessed by the UE is changed, an update is also needed.

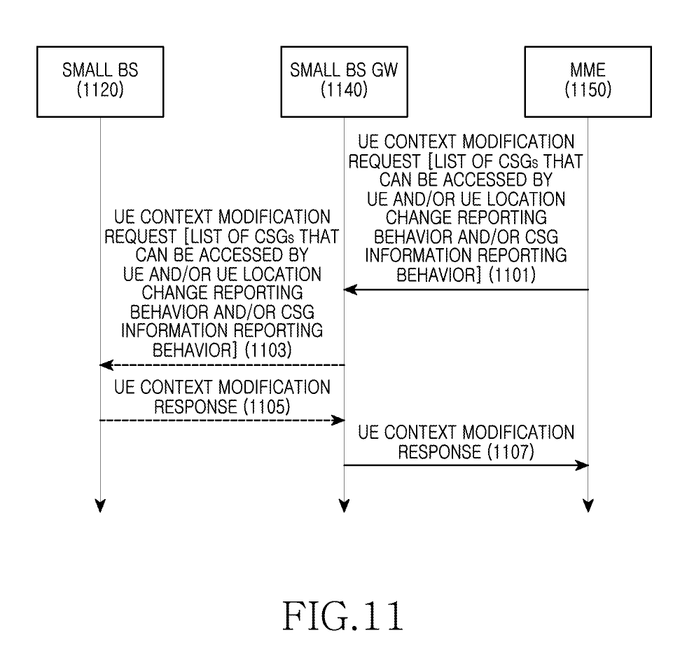

FIG. 11 is a flowchart illustrating a second exemplary embodiment of an updating process according to an exemplary embodiment of the present invention.

Referring to FIG. 11, in step 1101, the MME 1150 updates a list of CSGs that can be accessed by the UE, and/or updates the UE location change reporting action, and/or updates the CSG information reporting action, and transmits to the small BS GW 1140 a UE context modification request message, with the list of CSGs that can be accessed by the UE and/or the UE location change reporting action and/or the CSG information reporting action carried therein.

In step 1103, the small BS GW 1140 transmits to the small BS 1120 a UE context modification request message, with the list of CSGs that can be accessed by the UE and/or the UE location change reporting action and/or the CSG information reporting action carried therein. In step 1105, the small BS 1120 transmits a UE context modification response message to the small BS GW 1140. In an exemplary implementation, steps 1103 and 1105 are optional. In step 1107, the small BS GW 1140 transmits a UE context modification response message to the MME 1150.

The handover implemented through method (2) will be described below with reference to specific exemplary embodiments.

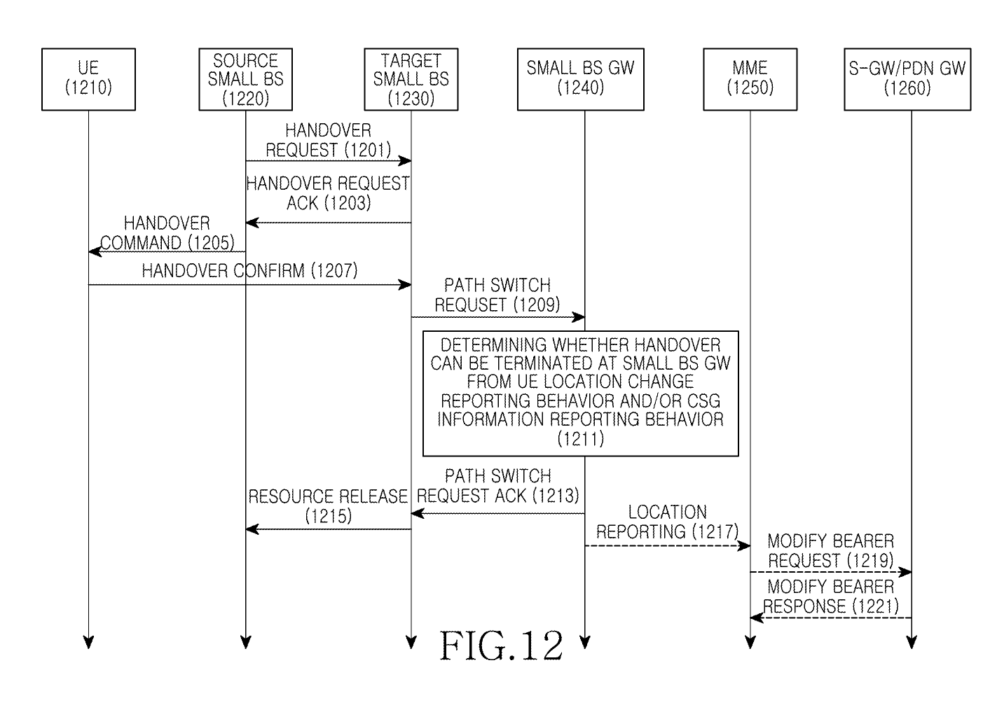

FIG. 12 is a flowchart illustrating a fourth exemplary embodiment of a handover process according to an exemplary embodiment of the present invention.

Referring to FIG. 12, in step 1201, the source small BS 1220 transmits a handover request message to the target small BS 1230. In a practical application, if the target cell to which the UE 1210 is to be handed over is of a CSG type, and the CSG identifier of the target cell is different from the CSG identifier of the source cell serving the UE 1210 (including the case in which the source cell is not of the CSG type), it needs to implement an access control on the UE 1210, i.e., to determine whether the UE 1210 can access the target cell. If not, the handover fails. Whether the UE 1210 can access the target cell can be determined by determining whether the CSG identifier of the target cell is included in the list of accessible CSGs. If the target cell is of hybrid type, it also needs to implement an access control, i.e., to determine whether the UE 1210 is a CSG member of the target cell and different QoS are provided depending on the determination result. Whether the UE 1210 is the member can be determined based on the list of accessible CSGs. If the source cell and target cell are in the same CSG, no access control needs to be implemented.

The access control may be implemented in the source small BS 1220, the small BS GW 1240 or the target small BS 1230. If implemented in the source or target small BS 1230, the CSG identifier of the target cell and the list of CSGs that can be accessed by the UE 1210 should to be transmitted to the source or target small BS 1230. How to obtain the CSG identifier of the target cell is included in the related art and thus a description thereof is omitted for conciseness in explanation. The methods in which the source small BS 1220 and the small BS GW 1240 obtain the list of CSGs that can be accessed by the UE 1210 have been described with reference in the previous exemplary embodiments and thus will not be repeated here for conciseness in explanation. The source small BS 1220 may transmit the list of CSGs that can be accessed by the UE 1210 to the target small BS 1230 through the handover request message in this step.

In step 1203, the target small BS 1230 allocates resources for the UE 1210 and transmits a handover request acknowledge message to the source small BS 1220. In step 1205, the source small BS 1220 transmits a handover command message to the UE 1210. In step 1207, the UE 1210 transmits a handover confirm message to the target small BS 1230. In step 1209, the target small BS 1230 transmits a path switch request message to the small BS GW 1240.

In step 1211, the small BS GW 1240 determines whether the handover could be terminated at the small BS GW 1240 from the received UE location change reporting action and/or CSG information reporting action. For example, if the UE 1210 location change reporting action is received and the content of the UE 1210 location change reporting action is stopping reporting, and/or, the CSG information reporting action is received and the content of the CSG information reporting action is not reporting when the UE 1210 enters/leaves/accesses a CSG cell, not reporting when the UE 1210 enters/leaves/accesses a subscribed hybrid cell, and not reporting when the UE 1210 enters/leaves/accesses an unsubscribed hybrid cell, then it is determined that the handover could be terminated at the small BS GW 1240. Afterwards, steps 1213 to 1215 are performed. If the UE 1210 location change reporting action is received and the content of the UE 1210 location change reporting action is not stopping reporting, such as beginning to report an ECGI, and/or, the CSG information reporting action is received and the content of the CSG information reporting action is reporting when the UE 1210 enters/leaves/accesses a CSG cell, reporting when the UE 1210 enters/leaves/accesses a subscribed hybrid cell, and reporting when the UE 1210 enters/leaves/accesses an unsubscribed hybrid cell, then it is determined that the handover cannot be terminated at the small BS GW 1240, and the handover is implemented where the handover is terminated at an MME 1260. In this case, alternatively, it may be determined that the handover could be terminated at the small BS GW 1240. Afterwards, steps 1213 to 1221 are performed. In addition, other information, such as whether transmission of user plane data is implemented through one tunnel or two tunnels, may also be taken into account to determine whether the handover could be terminated at the small BS GW 1240.

In step 1213, the small BS GW 1240 transmits a path switch request acknowledge message to the target small BS 1230. In step 1215, the target small BS 1230 transmits a resource release message to the source small BS 1220.

In step 1217, if a reporting condition is met, the small BS GW 1240 transmits to the MME 1250 an S1AP message, such as a location reporting message, with the information to be reported, i.e., UE location information, such as an ECGI and a TAI, carried therein. In addition, the S1AP message may further include CSG information carried therein. The CSG information includes a CSG identifier of the cell, a cell access mode, the UE membership status, i.e., being a CSG member or non-CSG member, and so on. In a practical application, the UE location information and the CSG information may be carried in two messages separately or in one message. The specific implementations are not limited.

In step 1219, the MME 1250 transmits to the S-GW/PDN_GW 1260 a modify bearer request message, with the UE location information such as an ECGI and a TAI and/or the CSG information transmitted from the small BS GW 1240, carried therein so that the S-GW/PDN_GW 1260 implements the functions of charging and so on using such information. The CSG information includes a CSG identifier of the cell, a cell access mode, the UE membership status, i.e., being a CSG member or non-CSG member, and so on. In a practical application, the UE location information and the CSG information may be carried in two messages separately or in one message. The specific implementations are not limited.

In step 1221, the S-GW/PDN_GW 1260 transmits a modify bearer response message to the MME 1250.

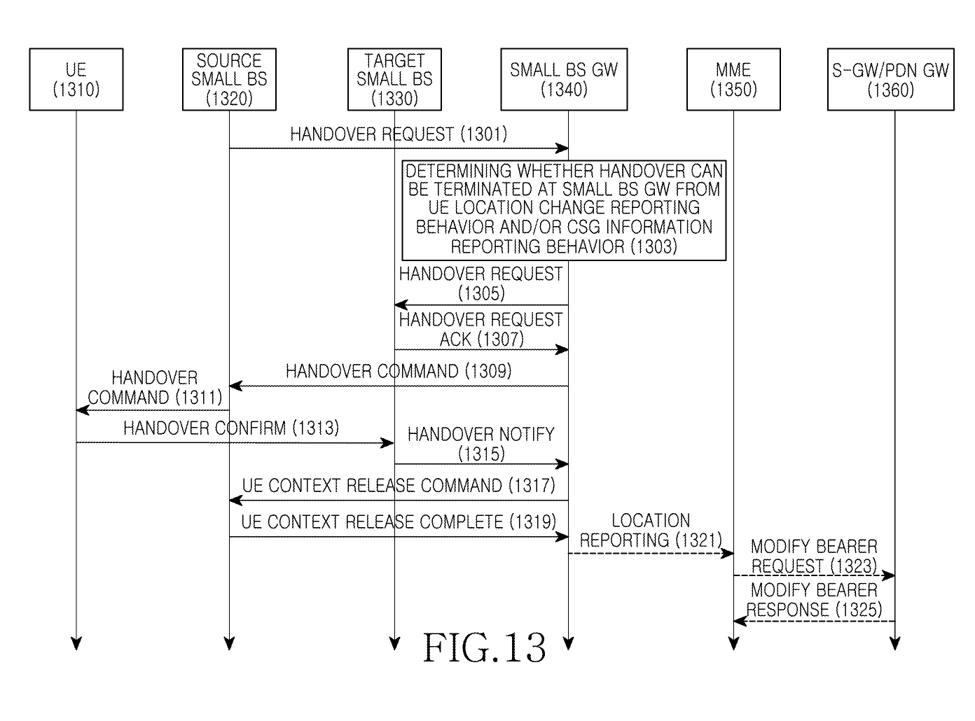

FIG. 13 is a flowchart illustrating a fifth exemplary embodiment of a handover process according to an exemplary embodiment of the present invention.

Referring to FIG. 13, in step 1301, the source small BS 1320 transmits a handover request message to the small BS GW 1340.

In step 1303, the small BS GW 1340 determines whether the handover could be terminated at the small BS GW 1340 from the UE location change reporting action and/or CSG information reporting action. For example, if the UE location change reporting action is received and the content of the UE location change reporting action is stopping reporting, and/or, the CSG information reporting action is received and the content of the CSG information reporting action is not reporting when the UE 1310 enters/leaves/accesses a CSG cell, not reporting when the UE 1310 enters/leaves/accesses a subscribed hybrid cell, and not reporting when the UE 1310 enters/leaves/accesses an unsubscribed hybrid cell, then it is determined that the handover could be terminated at the small BS GW 1340. Afterwards, steps 1305 to 1319 are performed. If the UE location change reporting action is received and the content of the UE location change reporting action is not stopping reporting, such as beginning to report an ECGI, and/or, the CSG information reporting action is received and the content of the CSG information reporting action is reporting when the UE 1310 enters/leaves/accesses a CSG cell, reporting when the UE 1310 enters/leaves/accesses a subscribed hybrid cell, and reporting when the UE 1310 enters/leaves/accesses an unsubscribed hybrid cell, then it is determined that the handover cannot be terminated at the small BS GW 1340, and the handover is implemented where the handover is terminated at an MME 1360. In this case, alternatively, it may be determined that the handover could be terminated at the small BS GW 1340. Afterwards, steps 1305 to 1325 are performed. In addition, other information, such as whether transmission of user plane data is implemented through one tunnel or two tunnels, may also be taken into account to determine whether the handover could be terminated at the small BS GW 1340.

In step 1305, the small BS GW 1340 transmits a handover request message to the target small BS 1330. In step 1307, the target small BS 1330 allocates resources for the UE 1310 and transmits a handover request acknowledge message to the small BS GW 1340. In step 1309, the small BS GW 1340 transmits a handover command message to the source small BS 1320. In step 1311, the source small BS 1320 transmits a handover command message to the UE 1310. In step 1313, the UE 1310 transmits a handover confirm message to the target small BS 1330. In step 1315, the target small BS 1330 transmits a handover notify message to the small BS GW 1340. In step 1317, the small BS GW 1340 transmits a UE context release command message to the source small BS 1320. In step 1319, the source small BS 1320 transmits a UE context release complete message to the small BS GW 1340.

In step 1321, if a reporting condition is met, the small BS GW 1340 transmits to the MME 1350 an S1AP message, such as a location reporting message, with the information to be reported, i.e., UE location information, such as an ECGI and a TAI, carried therein. In addition, the S1AP message may further include CSG information carried therein. The CSG information includes a CSG identifier of the cell, a cell access mode, the UE membership status, i.e., being a CSG member or non-CSG member, and so on. In a practical application, the UE location information and the CSG information may be carried in two messages separately or in one message. The specific implementations are not limited.

In step 1323, the MME 1350 transmits to the S-GW/PDN_GW 1360 a modify bearer request message, with the UE location information such as an ECGI and a TAI and/or the CSG information transmitted from the small BS GW 1340, carried therein so that the S-GW/PDN_GW 1360 implements the functions of charging and so on using such information. The CSG information includes a CSG identifier of the cell, a cell access mode, the UE membership status, i.e., being a CSG member or non-CSG member, and so on. In a practical application, the UE location information and the CSG information may be carried in two messages separately or in one message. The specific implementations are not limited.

In step 1325, the S-GW/PDN_GW 1360 transmits a modify bearer response message to the MME 1350.

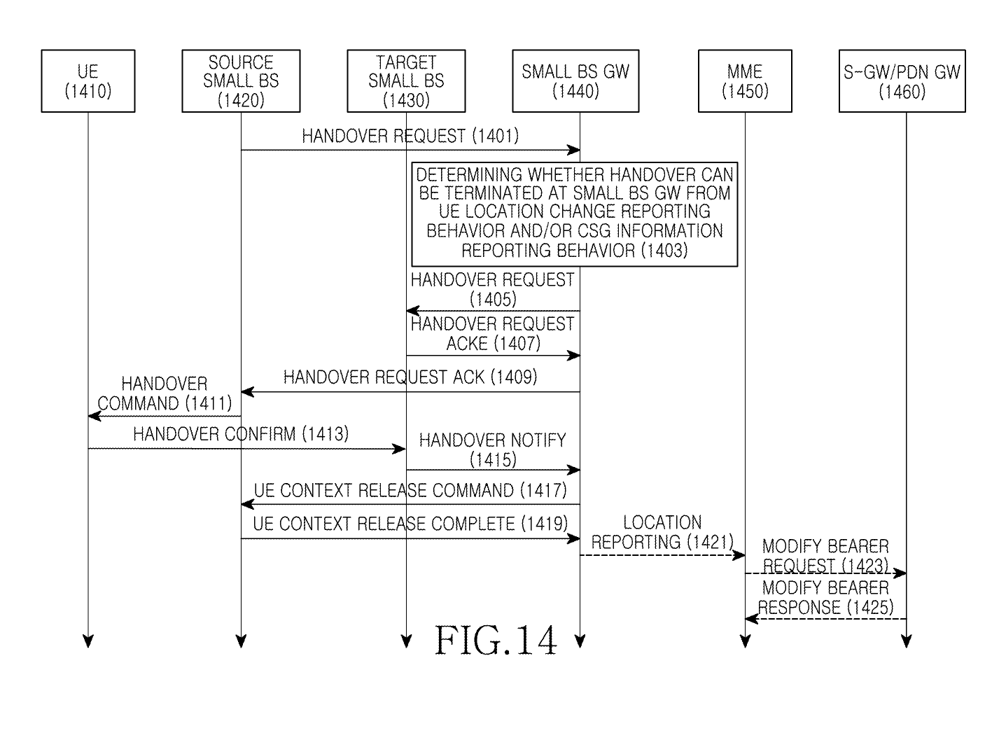

FIG. 14 is a flowchart illustrating a sixth exemplary embodiment of a handover process according to an exemplary embodiment of the present invention.

Referring to FIG. 14, in step 1401, the source small BS 1420 transmits a handover request message to the small BS GW 1440.

In step 1403, the small BS GW 1440 determines whether the handover could be terminated at the small BS GW 1440 from the UE 1410 location change reporting action and/or CSG information reporting action. For example, if the UE 1410 location change reporting action is received and the content of the UE 1410 location change reporting action is stopping reporting, and/or, the CSG information reporting action is received and the content of the CSG information reporting action is not reporting when the UE 1410 enters/leaves/accesses a CSG cell, not reporting when the UE 1410 enters/leaves/accesses a subscribed hybrid cell, and not reporting when the UE 1410 enters/leaves/accesses an unsubscribed hybrid cell, then it is determined that the handover could be terminated at the small BS GW 1440. Afterwards, steps 1405 to 1419 are performed. If the UE 1410 location change reporting action is received and the content of the UE 1410 location change reporting action is not stopping reporting, such as beginning to report an ECGI, and/or, the CSG information reporting action is received and the content of the CSG information reporting action is reporting when the UE 1410 enters/leaves/accesses a CSG cell, reporting when the UE 1410 enters/leaves/accesses a subscribed hybrid cell, and reporting when the UE 1410 enters/leaves/accesses an unsubscribed hybrid cell, then it is determined that the handover cannot be terminated at the small BS GW 1440, and the handover is implemented where the handover is terminated at an MME. In this case, alternatively, it may be determined that the handover could be terminated at the small BS GW 1440. Afterwards, steps 1405 to 1425 are performed.

In step 1405, the small BS GW 1440 transmits a handover request message to the target small BS 1430. As illustrated in FIG. 13, in steps 1301 and 1305 the small BSs exchange information with the small BS GW through S1 interfaces. However, in steps 1401 and 1405, the small BSs exchange information with the small BS GW 1440 through X2 interfaces, where in step 1401, the source small BS 1420 transmits an X2AP handover request message to the small BS GW 1440 and in step 1405, the small BS GW 1440 transmits an X2AP handover request message to the target small BS 1430.

In step 1407, the target small BS 1430 allocates resources for the UE 1410 and transmits a handover request acknowledge message to the small BS GW 1440. In step 1409, the small BS GW 1440 transmits a handover request acknowledge message to the source small BS 1420. As illustrated in FIG. 13, in steps 1307 and 1309, the small BSs exchange information with the small BS GW through S1 interfaces. However, in steps 1406 and 1409, the small BSs exchange information with the small BS GW 1440 through X2 interfaces, where in step 1404, the target small BS 1430 transmits an X2AP handover request acknowledge message to the small BS GW 1440 and in step 1405, the small BS GW 1440 transmits an X2AP handover request acknowledge message to the source small BS 1420.

In step 1411, the source small BS 1420 transmits a handover command message to the UE. In step 1413, the UE 1410 transmits a handover confirm message to the target small BS 1430. In step 1415, the target small BS 1430 transmits a handover notify message to the small BS GW 1440. In this step, the target small BS 1430 transmits a handover notify message to the small BS GW 1440 through an S1 interface. Alternatively, an X2 interface may be used so that the target small BS 1430 transmits a path switch request message to the small BS GW 1440 and the small BS GW 1440 returns a path switch request acknowledge message to the target small BS 1430.

In step 1417, the small BS GW 1440 transmits a UE context release command message to the source small BS 1420. In step 1419, the source small BS 1420 transmits a UE context release complete message to the small BS GW 1440. In steps 1417 and 1419, an S1 interface is used between the small BS GW 1440 and the source small BS 1420. Alternatively, an X2 interface may be used so that the target small BS 1430 transmits a resource release message to the small BS GW 1440 and the small BS GW 1440 transmits an X2AP resource release message to the source small BS 1420.

In step 1421, if a reporting condition is met, the small BS GW 1440 transmits to the MME 1450 an S1AP message, such as a location reporting message, with the information to be reported, i.e., UE location information, such as an ECGI and a TAI, carried therein. In addition, the S1AP message may further include CSG information carried therein. The CSG information includes a CSG identifier of the cell, a cell access mode, the UE membership status, i.e., being a CSG member or non-CSG member, and so on. In a practical application, the UE location information and the CSG information may be carried in two messages separately or in one message. The specific implementations are not limited.

In step 1423, the MME 1450 transmits to the S-GW/PDN_GW 1460 a modify bearer request message, with the UE location information such as an ECGI and a TAI and/or the CSG information transmitted from the small BS GW 1440, carried therein so that the S-GW/PDN_GW 1460 implements the functions of charging and so on using such information. The CSG information includes a CSG identifier of the cell, a cell access mode, the UE membership status, i.e., being a CSG member or non-CSG member, and so on. In a practical application, the UE location information and the CSG information may be carried in two messages separately or in one message. The specific implementations are not limited.

In step 1425, the S-GW/PDN_GW 1460 transmits a modify bearer response message to the MME 1450.

Moreover, the technical solution of exemplary embodiments of the present invention also proposes implementation (3) as follows.

If transmission of user plane data is implemented always through two tunnels, upon receiving a message indicating the handover of the UE, the gateway implements the handover in a way of being terminated at the gateway. Alternatively, upon receiving a message indicating the handover of the UE, the gateway determines whether the handover could be terminated at the gateway from whether transmission of user plane data is implemented through one tunnel or two tunnels, and if yes, implements the handover in a way of being terminated at the gateway, or otherwise, implements the handover in a way of not being terminated at the gateway. After implementing the handover in a way of being terminated at the gateway, the gateway transmits the UE location information and/or the CSG information to the MME.

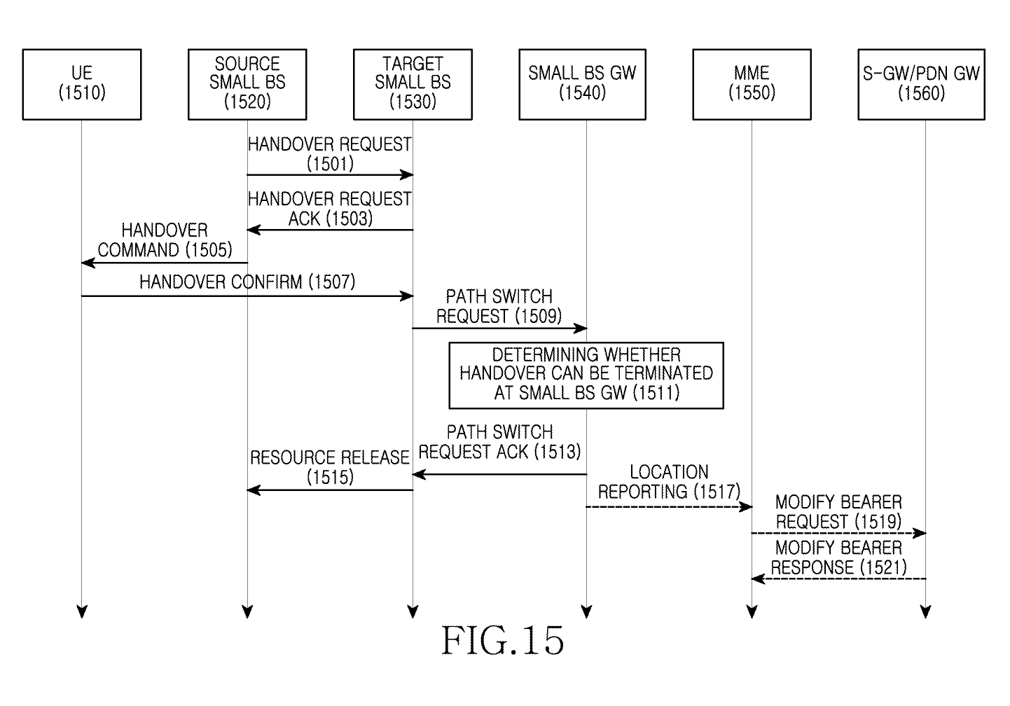

FIG. 15 is a flowchart illustrating a seventh exemplary embodiment of a handover process according to an exemplary embodiment of the present invention.

Referring to FIG. 15, in step 1501, the source small BS 1520 transmits a handover request message to the target small BS 1530. In a practical application, if the target cell to which the UE 1510 is to be handed over is of a CSG type, and the CSG identifier of the target cell is different from the CSG identifier of the source cell serving the UE 1510 (including the case in which the source cell is not of the CSG type), it needs to implement an access control on the UE 1510, i.e., to determine whether the UE 1510 can access the target cell. If not, the handover fails. Whether the UE 1510 can access the target cell can be determined by determining whether the CSG identifier of the target cell is included in the list of accessible CSGs. If the target cell is of hybrid type, it also needs to implement an access control, i.e., to determine whether the UE 1510 is a CSG member of the target cell and different QoS are provided depending on the determination result. Whether the UE 1510 is the member can be determined based on the list of accessible CSGs. If the source cell and target cell are in the same CSG, no access control needs to be implemented.

The access control may be implemented in the source small BS 1520, the small BS GW 1540 or the target small BS 1530. If in the source or target small BS 1530, the CSG identifier of the target cell and the list of CSGs that can be accessed by the UE 1510 should be transmitted to the source or target small BS 1530. How to obtain the CSG identifier of the target cell is included in the related art and thus a description thereof is omitted for conciseness in explanation. The methods in which the source small BS 1520 and the small BS GW 1540 obtain the list of CSGs that can be accessed by the UE 1510 have been described with reference in the previous exemplary embodiments and thus will not be repeated here for conciseness in explanation. The source small BS 1520 may transmit the list of CSGs that can be accessed by the UE 1510 to the target small BS 1530 through the handover request message in this step.

In step 1503, the target small BS 1530 allocates resources for the UE 1510 and transmits a handover request acknowledge message to the source small BS 1520. In step 1505, the source small BS 1520 transmits a handover command message to the UE 1510. In step 1507, the UE 1510 transmits a handover confirm message to the target small BS 1530. In step 1509, the target small BS 1530 transmits a path switch request message to the small BS GW 1540.

In step 1511, the small BS GW 1540 determines whether the handover could be terminated at the small BS GW 1540 from whether transmission of user plane data is implemented through one tunnel or two tunnels. In the case of two tunnels, the small BS GW 1540 determines that the handover could be terminated at the small BS GW 1540 and step 1513 is performed. In the case of one tunnel, the small BS GW 1540 determines that the handover cannot be terminated at the small BS GW 1540, and the handover is implemented where the handover is terminated at an MME 1550. Alternatively, if the small BS GW 1540 establishes a user plane for the UE 1510 always through two tunnels, i.e., the transmission of user plane data is implemented always through two tunnels, upon receiving the path switch request message in step 1509, the small BS GW 1540 performs step 1513 directly without needing to perform step 1511. The step 1511 is therefore optional.

In step 1513, the small BS GW 1540 transmits a path switch request acknowledge message to the target small BS 1530. In step 1515, the target small BS 1530 transmits a resource release message to the source small BS 1520.

In step 1517, the small BS GW 1540 transmits to the MME 1550 an S1AP message, such as a location reporting message, with UE location information and/or CSG information carried therein. The UE location information includes e.g., an ECGI, a TAI and so on. The CSG information includes a CSG identifier of the cell, a cell access mode, an UE membership status, i.e., being a CSG member or non-CSG member, and so on. If the target cell is of open type, there is no CSG information.

In step 1519, when determining that a reporting condition is met from the stored UE location change reporting action and/or CSG information reporting action, the MME 1550 transmits to the S-GW/PDN_GW 1560 a modify bearer request message, with the UE location information and/or the CSG information that the S-GW/PDN_GW 1560 requests to report, carried therein so that the S-GW/PDN_GW 1560 implements the functions of charging and so on using such information. The CSG information includes a CSG identifier of the cell, a cell access mode, an UE membership status, i.e., being a CSG member or non-CSG member, and so on. In step 1521, the S-GW/PDN_GW 1560 transmits a modify bearer response message to the MME 1550.

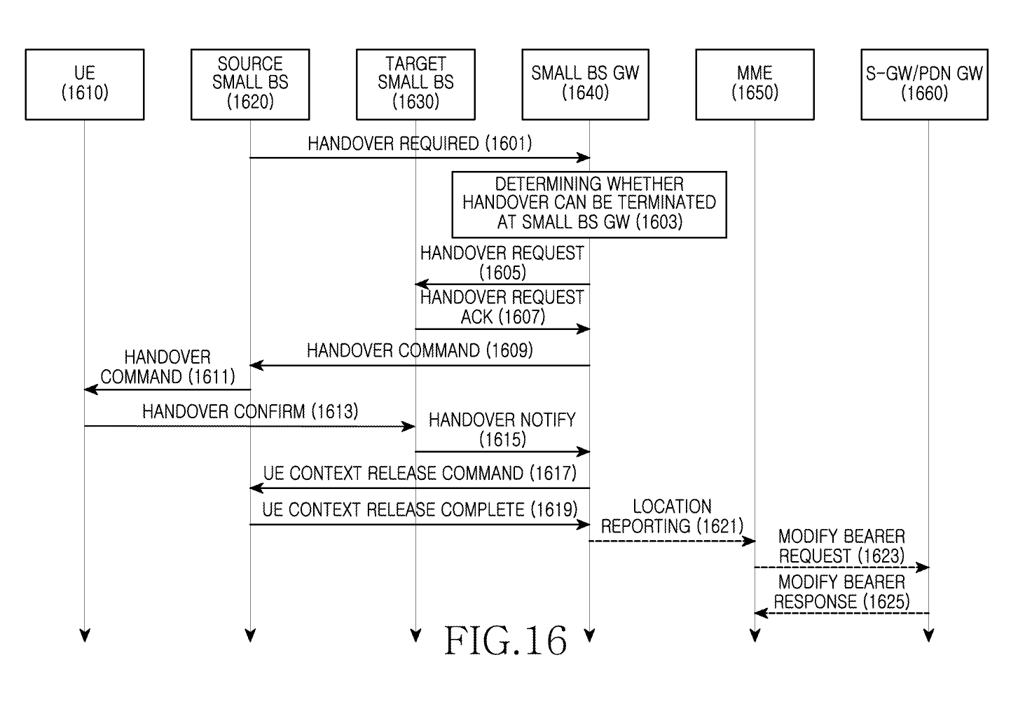

FIG. 16 is a flowchart illustrating an eighth exemplary embodiment of a handover process according to an exemplary embodiment of the present invention.

Referring to FIG. 16, in step 1601, the source small BS 1620 transmits a handover required message to the small BS GW 1640.

In step 1603, the small BS GW 1640 determines whether the handover could be terminated at the small BS GW 1640 from whether transmission of user plane data is implemented through one tunnel or two tunnels, and in the case of two tunnels, determines that the handover could be terminated at the small BS GW 1640 and step 1605 is performed, or in the case of one tunnel, determines that the handover cannot be terminated at the small BS GW 1640, and the handover is implemented where the handover is terminated at an MME 1650. Alternatively, if the small BS GW 1640 establishes a user plane for the UE 1610 always through two tunnels, i.e., the transmission of user plane data is implemented always through two tunnels, upon receiving the handover required message in step 1601, the small BS GW 1640 performs step 1605 directly without needing to perform step 1603. In an exemplary implementation, step 1603 is therefore optional.

In step 1605, the small BS GW 1640 transmits a handover request message to the target small BS 1630. In step 1607, the target small BS 1630 allocates resources for the UE 1610 and transmits a handover request acknowledge message to the small BS GW 1640. In step 1609, the small BS GW 1640 transmits a handover command message to the source small BS 1620. In step 1611, the source small BS 1620 transmits a handover command message to the UE 1610. In step 1613, the UE 1610 transmits a handover confirm message to the target small BS 1630. In step 1615, the target small BS 1630 transmits a handover notify message to the small BS GW 1640. In step 1617, the small BS GW 1640 transmits a UE context release command message to the source small BS 1620. In step 1619, the source small BS 1620 transmits a UE context release complete message to the small BS GW 1640.

In step 1621, the small BS GW 1640 transmits to the MME 1650 an S1AP message, such as a location reporting message, with UE location information and/or CSG information carried therein. The UE location information includes e.g., an ECGI, a TAI and so on. The CSG information includes a CSG identifier of the cell, a cell access mode, an UE membership status, i.e., being a CSG member or non-CSG member, and so on. If the target cell is of open type, there is no CSG information.

In step 1623, when determining that a reporting condition is met from the stored UE location change reporting action and/or CSG information reporting action, the MME 1650 transmits to the S-GW/PDN_GW 1660 a modify bearer request message, with the UE location information and/or the CSG information that the S-GW/PDN_GW 1660 requests to report, carried therein so that the S-GW/PDN_GW 1660 implements the functions of charging and so on using such information. The CSG information includes a CSG identifier of the cell, a cell access mode, an UE membership status, i.e., being a CSG member or non-CSG member, and so on. In step 1625, the S-GW/PDN_GW 1660 transmits a modify bearer response message to the MME 1650.

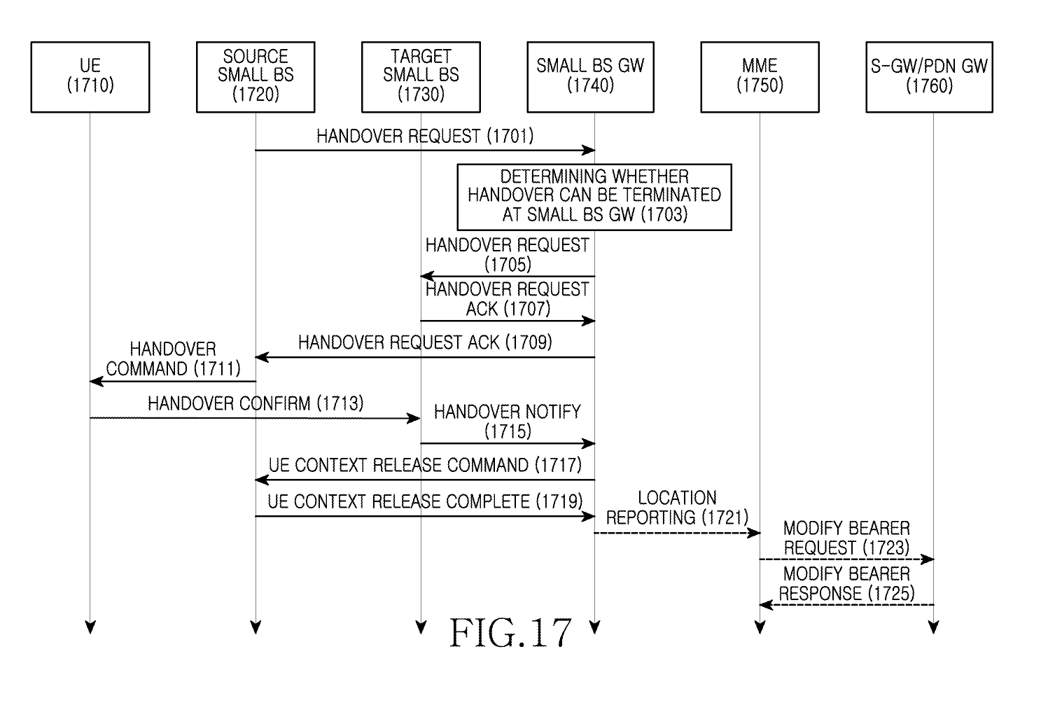

FIG. 17 is a flowchart illustrating a ninth exemplary embodiment of a handover process according to an exemplary embodiment of the present invention.

Referring to FIG. 17, in step 1701, the source small BS 1720 transmits a handover request message to the small BS GW 1740.

In step 1703, the small BS GW 1740 determines whether the handover could be terminated at the small BS GW 1740 from whether transmission of user plane data is implemented through one tunnel or two tunnels, and in the case of two tunnels, determines that the handover could be terminated at the small BS GW 1740 and step 1705 is performed, or in the case of one tunnel, determines that the handover cannot be terminated at the small BS GW 1740, and the handover is implemented subsequently according to the existing method. Alternatively, if the small BS GW 1740 establishes a user plane for the UE 1710 always through two tunnels, i.e., the transmission of user plane data is implemented always through two tunnels, upon receiving the handover request message in step 1701, the small BS GW 1740 performs step 1703 directly without needing to perform step 1702. Accordingly, step 1702 is optional.

In step 1705, the small BS GW 1740 transmits a handover request message to the target small BS 1730. As illustrated in FIG. 13, in steps 1301 and 1305 the small BSs exchange information with the small BS GW through S1 interfaces. However, in steps 1701 and 1705, the small BSs exchange information with the small BS GW 1740 through X2 interfaces, where in step 1701, the source small BS 1720 transmits an X2AP handover request message to the small BS GW 1740 and in step 1703, the small BS GW 1740 transmits an X2AP handover request message to the target small BS 1730.

In step 1707, the target small BS 1730 allocates resources for the UE 1710 and transmits a handover request acknowledge message to the small BS GW 1740. In step 1709, the small BS GW 1740 transmits a handover request acknowledge message to the source small BS 1720. As illustrated in FIG. 13, in steps 1307 and 1309, the small BSs exchange information with the small BS GW through S1 interfaces. However, in steps 1707 and 1709, the small BSs exchange information with the small BS GW 1740 through X2 interfaces, where in step 1707, the target small BS 1730 transmits an X2AP handover request acknowledge message to the small BS GW 1740 and in step 1709, the small BS GW 1740 transmits an X2AP handover request acknowledge message to the source small BS 1720.

In step 1711, the source small BS 1720 transmits a handover command message to the UE. In step 1713, the UE 1710 transmits a handover confirm message to the target small BS 1730. In step 1715, the target small BS 1730 transmits a handover notify message to the small BS GW 1740. In this step, the target small BS 1730 transmits a handover notify message to the small BS GW 1740 through an S1 interface. Alternatively, an X2 interface may be used so that the target small BS 1730 transmits a path switch request message to the small BS GW 1740 and the small BS GW 1740 returns a path switch request acknowledge message to the target small BS 1730.

In step 1717, the small BS GW 1740 transmits a UE context release command message to the source small BS 1720. In step 1719, the source small BS 1720 transmits a UE context release complete message to the small BS GW 1740. In steps 1717 and 1719, an S1 interface is used between the small BS GW 1740 and the source small BS 1720. Alternatively, an X2 interface may be used so that the target small BS 1730 transmits a resource release message to the small BS GW 1740 and the small BS GW 1740 transmits an X2AP resource release message to the source small BS 1720.

In step 1721, if a reporting condition is met, the small BS GW 1740 transmits to the MME 1750 an S1AP message, such as a location reporting message, with the information to be reported, i.e., UE location information, such as an ECGI and a TAI, carried therein. In addition, the S1AP message may further include CSG information carried therein. The CSG information includes a CSG identifier of the cell, a cell access mode, the UE membership status, i.e., being a CSG member or non-CSG member, and so on. In a practical application, the UE location information and the CSG information may be carried in two messages separately or in one message. The specific implementations are not limited.

In step 1723, the MME 1750 transmits to the S-GW/PDN_GW 1760 a modify bearer request message, with the UE location information such as an ECGI and a TAI and/or the CSG information transmitted from the small BS GW 1740, carried therein so that the S-GW/PDN_GW 1760 implements the functions of charging and so on using such information. The CSG information includes a CSG identifier of the cell, a cell access mode, the UE membership status, i.e., being a CSG member or non-CSG member, and so on. In a practical application, the UE location information and the CSG information may be carried in two messages separately or in one message. The specific implementations are not limited. In step 1725, the S-GW/PDN_GW 1760 transmits a modify bearer response message to the MME 1750.

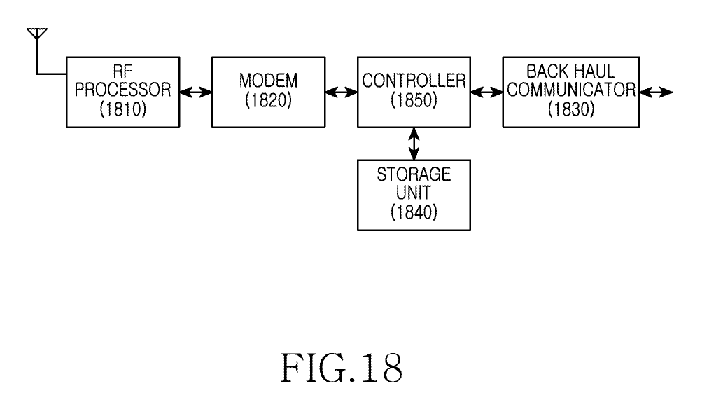

FIG. 18 is a block diagram of a small BS in a mobile communication system according to an exemplary embodiment of the present invention.

Referring to FIG. 18, the small BS includes a Radio Frequency (RF) processor 1810, a modem 1820, a backhaul communicator 1830, a storage unit 1840 and a controller 1850.

The RF processor 1810 performs functions, such as signal band conversion and amplification, to transmit and receive signals over a radio channel. That is, the RF processor 1810 up-converts a baseband signal output from the modem 1820 into the RF signal and transmits the RF signal over an antenna, and down-converts the RF signal received over the antenna into the baseband signal. For example, the RF processor 1810 may include an amplifier, a mixer, an oscillator, a Digital to Analog Convertor (DAC), an Analog to Digital Convertor (ADC) and so on.

The modem 1820 converts the baseband signal and a bit string according to a physical layer standard of the system. For example, to transmit data, the modem 1820 generates complex symbols by encoding and modulating the transmit bit string, maps the complex symbols to subcarriers, and constitutes Orthogonal Frequency-Division Multiplexing (OFDM) symbols by applying Inverse Fast Fourier Transform (IFFT) and inserting a Cyclic Prefix (CP). When receiving data, the modem 1820 splits the baseband signal output from the RF processor 1810 into OFDM symbols, restores the signals mapped to the subcarriers using FFT, and restores the receive bit string by demodulating and decoding the signals.

The backhaul communicator 1830 provides an interface for the small BS to communicate with other entities (i.e., a small BS GW, an MME and so on). More specifically, the backhaul communicator 1830 converts the bit string transmitted by the small BS into a physical signal, and converts the physical signal received at the small BS into the bit string. The storage unit 1840 stores program codes and system information required for the operations of the small BS. The storage unit 1840 provides stored data to the controller 1850 upon a request from the controller 1850.

The controller 1850 controls the functions of the small BS. For example, the controller 1850 generates a transmit packet and a message and provides the modem 1820 with the transmit packet and the message. And, the controller 1850 processes a receive packet and a message from the modem 1820. More particularly, according to an exemplary embodiment of the present invention, the controller 1850 supports a handover of a UE connected to the small BS. For example, the controller 1850 controls so that the small BS operates as illustrated in FIG. 3A to FIG. 17. That is, the controller 1850 interprets at least one control message from a UE, other small BSs, a small BS GW or an MME. The controller 1850 generates a control message and controls the RF processor 1810, the modem 1820 and the backhaul communicator 1830 to transmit the control message.

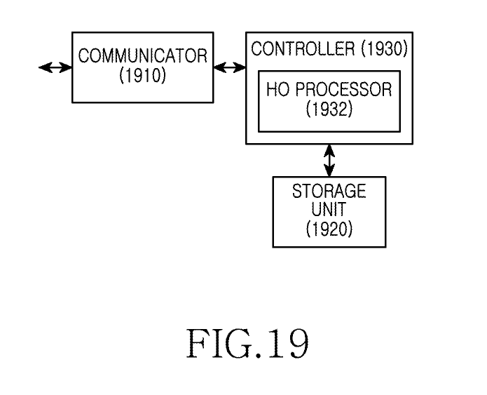

FIG. 19 is a block diagram of a gateway in a mobile communication system according to an exemplary embodiment of the present invention.

Referring to FIG. 19, the gateway includes a communicator 1910, a storage unit 1920, and a controller 1930.

The communicator 1910 provides an interface for the gateway to communicate with other entities (i.e., a small BS, an MME and so on). The storage unit 1920 stores program codes and system information required for the operations of the gateway.

The controller 1930 controls the functions of the gateway. For example, the controller 1930 manages a traffic flow of at least one small BS connected to the gateway. More particularly, according to an exemplary embodiment of the present invention, the controller 1930 controls a handover procedure of a gateway for a UE to perform a handover between small BSs connected to the gateway. Furthermore, the controller 1930 includes a handover (HO) processor 1932 that determines whether the handover could be terminated at the gateway and processes the handover procedure. For example, the controller 1930 controls so that the gateway operates as illustrated in FIG. 3A to FIG. 17. For example, the communicator 1910 receives a message informing of a handover of a UE from a BS, ant the controller 1930 determines whether the handover could be terminated at the gateway and performs a handover procedure in a way of being terminated at the gateway.

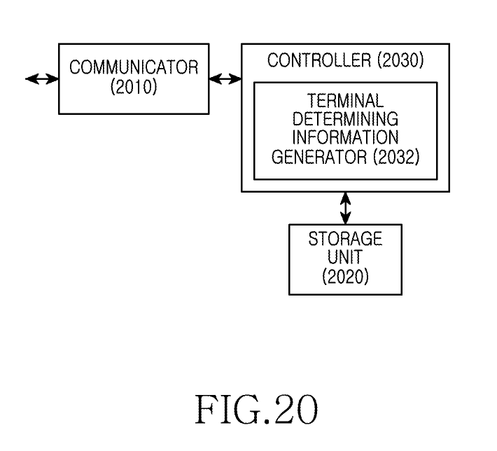

FIG. 20 is a block diagram of an MME in a mobile communication system according to an exemplary embodiment of the present invention.

Referring to FIG. 20, the MME includes a communicator 2010, a storage unit 2020, and a controller 2030.

The communicator 2010 provides an interface for the MME to communicate with other entities (i.e., a small BS, a small BS GW and so on). The storage unit 2020 stores program codes and system information required for the operations of the MME.

The controller 2030 controls the functions of the MME. More particularly, according to an exemplary embodiment of the present invention, the controller 2030 controls to terminate a handover of a UE performing a handover between small BSs at the gateway. Further, the controller 2030 includes a terminal-determining-information generator 2032 that generates reference information required for the gateway to determine whether the handover could be terminated at the gateway. The reference information may include at least one of a list of CSGs that can be accessed by the UE, the UE location change reporting action, CSG information reporting action, and, indicative information indicating whether the handover could be terminated at the gateway. For example, the controller 2030 controls so that the MME operates as illustrated in FIG. 3A to FIG. 17. For example, the communicator 2010 receives a message informing an access of a UE through a gateway, and the controller 2030 provide the gateway with reference information required for the gateway to determine whether the handover could be terminated at the gateway.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for an operation of a gateway in a mobile communication system, the method comprising:
receiving a message informing of a handover of a User Equipment (UE) from a Base Station (BS);
determining whether the handover could be terminated at the gateway; and
if it is determined the handover could be terminated at the gateway, performing the handover with the handover being terminated at the gateway.

2. The method of claim 1, wherein the determining of whether the handover could be terminated at the gateway comprises:
determining whether the handover could be terminated at the gateway according to indicative information, determined by a Mobile Management Entity (MME), indicating whether the handover could be terminated at the gateway.

3. The method of claim 1, wherein the determining of whether the handover could be terminated at the gateway comprises:
determining whether the handover could be terminated at the gateway according to a number of tunnels where transmission of user plane data is implemented.

4. The method of claim 3, wherein the determining of whether the handover could be terminated at the gateway comprises:
determining that the handover could be terminated at the gateway when the transmission of user plane data is implemented through two tunnels.

5. The method of claim 1, wherein the determining of whether the handover could be terminated at the gateway comprises:
determining whether the handover could be terminated at the gateway according to at least one of a UE location change reporting action and a Closed Subscriber Group (CSG) information reporting action.

6. The method of claim 5, wherein the determining of whether the handover could be terminated at the gateway comprises:
determining that the handover could be terminated at the gateway when at least one of a condition that the UE location change reporting action comprises stopping reporting, and a condition that the CSG information reporting action comprises not reporting when the UE enters/leaves/accesses a CSG cell, not reporting when the UE enters/leaves/accesses a subscribed hybrid cell, and not reporting when the UE enters/leaves/accesses an unsubscribed hybrid cell is satisfied.

7. The method of claim 1, further comprising:
receiving reference information required for the gateway to determine whether the handover could be terminated at the gateway from a Mobile Management Entity (MME).

8. The method of claim 7, wherein the reference information comprises at least one of a list of Closed Subscriber Groups (CSGs) that can be accessed by the UE, a UE location change reporting action, a CSG information reporting action, and, indicative information indicating whether the handover could be terminated at the gateway.

9. The method of claim 7, further comprising:
receiving updated reference information from the MME.

10. A method for an operation of a Mobile Management Entity (MME) in a mobile communication system, the method comprising:
receiving a message informing of an access of a User Equipment (UE) through a gateway;
transmitting reference information to the gateway that is used by the gateway to determine whether the handover could be terminated at the gateway.

11. The method of claim 10, wherein the reference information comprises at least one of a list of Closed Subscriber Groups (CSGs) that can be accessed by the UE, a UE location change reporting action, a CSG information reporting action, and, indicative information indicating whether the handover could be terminated at the gateway.

12. The method of claim 10, further comprising:
transmitting updated reference information when the reference information is updated.

13. The method of claim 10, further comprising:
determining whether the handover could be terminated at the gateway,
wherein the reference information comprises indicative information indicating whether the handover could be terminated at the gateway.

14. The method of claim 13, wherein the determining of whether the handover could be terminated at the gateway comprises:
determining whether the handover could be terminated at the gateway according to a number of tunnels where transmission of user plane data is implemented.

15. The method of claim 14, wherein the determining of whether the handover could be terminated at the gateway comprises:
determining that the handover could be terminated at the gateway when the transmission of user plane data is implemented through two tunnels.

16. The method of claim 13, wherein the determining of whether the handover could be terminated at the gateway comprises:
determining whether the handover could be terminated at the gateway according to at least one of a UE location change reporting action and a Closed Subscriber Group (CSG) information reporting action.

17. The method of claim 16, wherein the determining of whether the handover could be terminated at the gateway comprises:
determining that the handover could be terminated at the gateway when at least one of a condition that the UE location change reporting action comprises stopping reporting, and a condition that the CSG information reporting action comprises not reporting when the UE enters/leaves/accesses a CSG cell, not reporting when the UE enters/leaves/accesses a subscribed hybrid cell, and not reporting when the UE enters/leaves/accesses an unsubscribed hybrid cell is satisfied.

18. An apparatus for a gateway in a mobile communication system, the apparatus comprising:
a communicator for receiving a message informing of a handover of a User Equipment (UE) from a Base Station (BS); and
a controller for determining whether the handover could be terminated at the gateway and, if it is determined that the handover could be terminated at the gateway, for performing the handover with the handover being terminated at the gateway.

19. The apparatus of claim 18, wherein the controller determines whether the handover could be terminated at the gateway according to indicative information, determined by a Mobile Management Entity (MME), indicating whether the handover could be terminated at the gateway.

20. The apparatus of claim 18, wherein the controller determines whether the handover could be terminated at the gateway according to a number of tunnels where transmission of user plane data is implemented.

21. The apparatus of claim 20, wherein the controller determines that the handover could be terminated at the gateway when the transmission of user plane data is implemented through two tunnels.

22. The apparatus of claim 18, wherein the controller determines whether the handover could be terminated at the gateway according to at least one of a UE location change reporting action and a Closed Subscriber Group (CSG) information reporting action.

23. The apparatus of claim 22, wherein the controller determines that the handover could be terminated at the gateway when at least one of a condition that the UE location change reporting action comprises stopping reporting, and a condition that the CSG information reporting action comprises not reporting when the UE enters/leaves/accesses a CSG cell, not reporting when the UE enters/leaves/accesses a subscribed hybrid cell, and not reporting when the UE enters/leaves/accesses an unsubscribed hybrid cell is satisfied.

24. The apparatus of claim 18, wherein the communicator receives reference information required for the gateway to determine whether the handover could be terminated at the gateway from a Mobile Management Entity (MME).

25. The apparatus of claim 24, wherein the reference information comprises at least one of a list of Closed Subscriber Groups (CSGs) that can be accessed by the UE, a UE location change reporting action, a CSG information reporting action, and, indicative information indicating whether the handover could be terminated at the gateway.

26. The apparatus of claim 24, wherein the communicator receives updated reference information from the MME.

27. An apparatus for a Mobile Management Entity (MME) in a mobile communication system, the apparatus comprising:
a communicator for receiving a message informing of an access of a User Equipment (UE) through a gateway; and
a controller for providing the gateway with reference information that is used by the gateway to determine whether the handover could be terminated at the gateway.

28. The apparatus of claim 27, wherein the reference information comprises at least one of a list of Closed Subscriber Groups (CSGs) that can be accessed by the UE, a UE location change reporting action, a CSG information reporting action, and, indicative information indicating whether the handover could be terminated at the gateway.

29. The apparatus of claim 27, wherein the controller provides updated reference information when the reference information is updated.

30. The apparatus of claim 27, wherein the controller determines whether the handover could be terminated at the gateway,
wherein the reference information comprises indicative information indicating whether the handover could be terminated at the gateway.

31. The apparatus of claim 30, wherein the controller determines whether the handover could be terminated at the gateway according to a number of tunnels where transmission of user plane data is implemented.

32. The apparatus of claim 31, wherein the controller determines that the handover could be terminated at the gateway when the transmission of user plane data is implemented through two tunnels.

33. The apparatus of claim 30, wherein the controller determines whether the handover could be terminated at the gateway according to at least one of a UE location change reporting action and a Closed Subscriber Group (CSG) information reporting action.

34. The apparatus of claim 33, wherein the controller determines that the handover could be terminated at the gateway when at least one of a condition that the UE location change reporting action comprises stopping reporting, and a condition that the CSG information reporting action comprises not reporting when the UE enters/leaves/accesses a CSG cell, not reporting when the UE enters/leaves/accesses a subscribed hybrid cell, and not reporting when the UE enters/leaves/accesses an unsubscribed hybrid cell is satisfied.
